(19) United States
(12) Patent Application Publication
(10) Pub. No.: US 2010/0306094 A1
(43) Pub. Date: Dec. 2, 2010

(54) SYSTEMS, METHODS, AND APPARATUS FOR IDENTIFYING PAYEES FROM CLEARED ITEMS POSTED TO A FINANCIAL ACCOUNT

(75) Inventors: Robert T. Homer, Cumming, GA (US); Mary Elizabeth Lawson, Westerville, OH (US); Donald Kenneth Hobday, JR., Blacklick, OH (US); Hans Daniel Dreyer, Pataskala, OH (US)

Correspondence Address: SUTHERLAND II, SUTHERLAND, ASBILL & BRENNAN, LLC, 999 PEACHTREE STREET, ATLANTA, GA, 30309, US

(73) Assignee: FISERV, INC., Brookfield, WI (US)

(21) Appl. No.: 12/473,837

(22) Filed: May 28, 2009

(51) Int. Cl. G06Q 40/00; G06F 17/30

(52) U.S. Cl. 705/35; 707/E17.014; 707/E17.022

(57) ABSTRACT

Systems, methods, and apparatus for identifying payees from cleared items posted to a financial account are provided. Information associated with one or more cleared items posted to a financial account of a consumer may be obtained. Based at least in part on the obtained information, at least one payee may be identified. A suggestion to add the identified at least one payee as one of an electronic biller of the consumer or a payee of the consumer for online payment functionality may be generated, wherein receiving an acceptance of the suggestion facilitates activation of an associated service for the consumer by a service provider. The generated suggestion may be transmitted to a network entity for presentation to the consumer.

### CROSS-REFERENCE TO RELATED APPLICATION

This application is related to co-pending U.S. patent application Ser. No. ______ (Attorney Docket No. 23952-0391), filed ______, and entitled “Systems, Methods, and Apparatus for Establishing Payees Based on Cleared Items Posted to a Financial Account,” the disclosure of which is incorporated by reference herein in its entirety.

### FIELD OF THE INVENTION

Embodiments of the invention relate generally to online banking, and more particularly, to the identification of potential payees in online payment functionality for a customer based on cleared items posted to a financial account.

### BACKGROUND OF THE INVENTION

A wide variety of financial institutions provide online banking options to their customers. Online banking typically allows bank customers to review transactions that have posted to their financial accounts. These include “cleared items,” such as debit transactions and check transactions that have been paid out of an account. Some of these transactions may be associated with payees not yet established as payees of the bank customer in associated online bill presentment and/or online payment functionality. Recurring payments may also be available or appropriate in association with such payees. Banks have found that greater customer use of electronic bill presentment and/or online payment functionality often increases the “stickiness” of the customer to the bank. However, bank customers may be slow to adopt significant use of online payment functionality for a variety of reasons.

### BRIEF DESCRIPTION OF THE DRAWINGS

Reference will now be made to the accompanying drawings, which are not necessarily drawn to scale, and wherein:

FIG. 1 illustrates an example overview of a system that allows for identifying payees from cleared items posted to a financial account, according to an example embodiment of the invention.

FIG. 2 is a flow chart of an example method for generating payee suggestions for electronic bill presentment and or payment, according to an illustrative embodiment of the invention.

FIG. 3 is a flow chart of an example method for obtaining consumer preferences associated with the identification of payees for payee suggestions, according to an example embodiment of the invention.

FIG. 4 is a flow chart of an example method for identifying payees from check transactions for payee suggestions, according to an example embodiment of the invention.

FIG. 5 is a flow chart of an example method for identifying payees from electronic transactions for payee suggestions, according to an example embodiment of the invention.

FIG. 6 is a flow chart of an example method for identifying recurring payment opportunities, according to an example embodiment of the invention.

FIG. 7 is a flow chart of an example method for presenting payee suggestions to a consumer, according to an example embodiment of the invention.

### DETAILED DESCRIPTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As used herein, the term “cleared item” may refer to information posted to and/or stored in association with a financial account, such as a bank account, regarding a completed transaction utilizing the financial account. A wide variety of information may be associated with a cleared item, for example, a posting date, a description of the item, an indication of whether the cleared item is a debit or credit, an amount, and/or a running balance for the financial account. Additionally, a wide variety of different types of cleared items may be posted to a financial account as desired in various embodiments of the invention, including but not limited to, automatic teller machine (ATM) and/or teller withdrawals, bank fees, check or currency deposits, electronic credits, online payments, paid checks, converted checks, debit card transactions, direct debit transactions, etc.

As used herein, the term “cleared items history” may refer to a collection or set of cleared items associated with a financial account. A wide variety of different types of sets of cleared items may be utilized as desired in various embodiments of the invention. For example, a cleared items history may include cleared items that have been posted to a financial account during a predetermined time period, such as, during the last month, during the last three months, etc. As another example, a cleared items history may include a predetermined number of cleared items that have been posted to a financial account, such as, the last 50 cleared items or last 100 cleared items that were posted.

As used herein, the term “consumer” may refer to an individual, small business customer, or other customer of a financial institution, such as a bank, credit union, etc. The financial institution may manage one or more financial accounts of the consumer, for example, a checking account, money market account, etc.

Embodiments of the invention can provide systems, methods, apparatus, means, and/or mechanisms by which payees may be identified from one or more cleared items posted to a financial account and suggestions may be presented to a consumer for activating online payment services and/or electronic bill presentment for at least one of the identified payees. Information associated with one or more cleared items posted to a financial account, such as a bank account of a consumer, may be obtained. At least one payee of the consumer may be identified utilizing the obtained information. The at least one payee may be a payee that has not already been established as a payee for online payment services and/or electronic bill presentment. A suggestion to add the identified at least one payee as a payee of the consumer for electronic bill presentment and/or online payment functionality may be generated. These suggestions, once accepted by a consumer, may facilitate a bill payment service activating electronic bill presentment for bills of the payee and/or the distribution of payments to the payee on behalf of the consumer. Once a suggestion has been generated, the suggestion may be presented to the consumer.

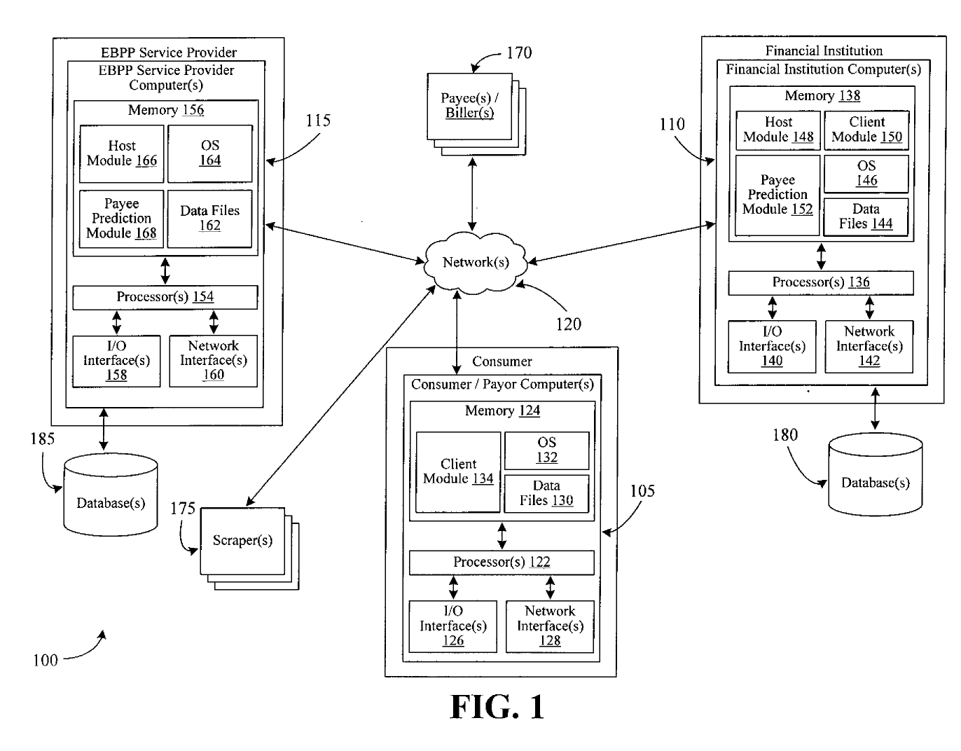

An example system 100 for identifying payees based upon cleared items posted to a financial account will now be described illustratively with respect to FIG. 1. In certain embodiments, the system 100 may include a consumer/payor computer 105, a financial institution computer 110, and an electronic bill payment and presentment (EBPP) service provider computer 115. For purposes of this disclosure, the consumer/payor computer 105 may be referred to as the consumer computer 105. Although various computing devices and/or computers are illustrated in FIG. 1 for the consumer/payor computer 105, the financial institution computer 110, and/or the EBPP service provider computer 115, it will be appreciated that these computers are associated with various individuals, businesses, and/or other entities. For example, the consumer/payor computer 105 may be associated with a consumer, the financial institution computer 110 may be associated with a suitable financial institution (e.g., bank), and the EBPP service provider computer 115 may be associated with a suitable business entity that provides electronic bill presentment and/or payment services to consumers. Additionally, as desired, the various individuals, businesses, and/or other entities may have any number of respective associated computers. A single computer is illustrated as being associated with each entity in FIG. 1 for ease in understanding various embodiments of the invention.

As desired, each of the consumer computer 105, financial institution computer 110, and/or EBPP service provider computer 115 may be one or more suitable computers, computing devices, and/or network entities that include one or more processors and/or processing devices that may be configured for accessing and reading associated computer-readable media having stored thereon data and/or computer-executable instructions for implementing the various methods of the invention. Additionally, in certain embodiments, the financial institution computer 110 and/or the EBPP service provider computer 115 may facilitate the identification of payees based upon cleared items posted to a financial account and the transmission or other communication of a suggestion to activate electronic bill presentment and/or distribution of payments to an identified payee.

Generally, computers, including one or more of the consumer computer 105, financial institution computer 110, and/or EBPP service provider computer 115 may include or otherwise be associated with suitable hardware and/or software for transmitting and receiving data over one or more communications links or networks. These computers may also include other internal and peripheral components that are well known in the art. By executing computer-executable instructions or software instructions, each of the computers or network devices may form a special purpose computer or particular machine. As used herein, the term “computer-readable medium” describes any form of suitable memory that may be accessed by a processor associated with a computer.

The consumer computer 105 may be any suitable processor-driven device that facilitates interaction with a consumer and communications with other network devices. The consumer computer may be, for example, a personal computer or network-enabled mobile device of a consumer. As desired, the consumer computer 105 may include any number of special purpose computers or other particular machines, application specific circuits, microcontrollers, personal computers, minicomputers, servers, and the like. In certain embodiments, the operations of the consumer computer 105 may be controlled by computer-executed or computer-implemented instructions that are executed by one or more processors associated with the consumer computer 105. The instructions may be embodied in one or more software components as desired in various embodiments of the invention. The execution of the instructions may form a special purpose computer or other particular machine that is operable to facilitate interaction with the consumer and communication with other network devices in order to receive suggestions to activate one or more payees for electronic bill presentment and/or distribution of payments on behalf of the consumer. The one or more processors that control the operations of the consumer computer 105 may be incorporated into the consumer computer 105 and/or in communication with the consumer computer 105 via one or more suitable networks. In certain embodiments of the invention, the operations and/or control of the consumer computer 105 may be distributed amongst several processing components.

The consumer computer 105 may include one or more processors 122, one or more memory devices 124, one or more input/output (“I/O”) interface(s) 126, and one or more network interface(s) 128. The one or more memory devices 124 may be any suitable memory devices, for example, caches, read only memory devices, random access memory devices, magnetic storage devices, etc. The one or more memory devices 124 may store data, executable instructions, and/or various program modules utilized by the consumer computer 105, for example, data files 130, an operating system 132, and/or a client module 134. The data files 130 may include any suitable data that facilitates interaction with the financial institution computer 110 and/or the EBPP service provider computer 115. For example, the data files 130 may include, but are not limited to, profile information for the consumer, log-in and/or access information for the consumer, and/or financial information, billing information, and/or payment information that has been received from the financial institution computer 110 and/or the EBPP service provider computer 115. The operating system (OS) 132 may be a suitable software module that controls the general operation of the consumer computer 105. The OS 132 may also facilitate the execution of other software modules by the one or more processors 122, for example, the client module 134. The client module 132 may be a suitable software module, such as an Internet browser, that facilitates interaction between the consumer and the financial institution computer 110 and/or the EBPP service provider computer 115. In this regard, the consumer may request and/or access various financial information and/or billing information. Additionally, suggestions may be presented to the consumer for establishing electronic bill presentment and/or various bill payment functionality for one or more payees of the consumer.

The one or more I/O interfaces 126 may facilitate communication between the consumer computer 105 and one or more input/output devices, for example, one or more user interface devices, such as, a display, keypad, mouse or other pointing device, control panel, touch screen display, remote control, microphone, etc. that facilitate consumer or user interaction with the consumer computer 105. In this regard, one or more user preferences and/or commands associated with the operation of the consumer computer 105 may be received and processed.

The one or more network interfaces 128 may facilitate connection of the consumer computer 105 to one or more suitable networks, for example, a wide area network, the Internet, a cellular network, any wired network, any wireless network, etc. In this regard, the consumer computer 105 may receive and/or communicate information to other network components of the system 100, such as the financial institution computer 110 and/or the EBPP service provider computer 115.

Although a single consumer/payor computer 105 is illustrated in FIG. 1, as desired in various embodiments of the invention, any number of consumer/payor computers may be in communication with the financial institution computer 110 and/or the EBPP service provider computer 115. Furthermore, any number of consumer/payor computers may be associated with a particular consumer. In this regard, any number of consumers may be in communication with the financial institution computer 110 and/or the EBPP service provider computer 115. Additionally, a consumer/payor computer 105 may include more or less than the components illustrated in FIG. 1. The consumer payor computer 105 illustrated in FIG. 1 is provided by way of example only.

With continued reference to FIG. 1, the financial institution computer 110 may be any suitable processor-driven device that facilitates interaction with other network devices of the system 100 and/or the provision of various online banking services. The financial institution computer 110 may be associated with a financial institution, such as a bank, that provides services for one or more financial accounts of the consumer, such as, a checking account, money market account, etc. As desired, the financial institution computer 110 may include any number of special purpose computers or other particular machines, application specific circuits, microcontrollers, personal computers, minicomputers, servers, and the like. In certain embodiments, the operations of the financial institution computer 110 may be controlled by computer-executed or computer-implemented instructions that are executed by one or more processors associated with the financial institution computer 110. The instructions may be embodied in one or more software components as desired in various embodiments of the invention. The execution of the instructions may form a special purpose computer or other particular machine that is operable to facilitate the provision of online banking services to one or more consumers and/or the transmission, communication, and/or presentation of one or more suggestions to activate one or more payees for electronic bill presentment and/or distribution of payments on behalf of the consumer. The one or more processors that control the operations of the financial institution computer 110 may be incorporated into the financial institution computer 110 and/or in communication with the financial institution computer 110 via one or more suitable networks. In certain embodiments of the invention, the operations and/or control of the financial institution computer 110 may be distributed amongst several processing components.

The financial institution computer 110 may include one or more processors 136, one or more memory devices 138, one or more input/output (“I/O”) interface(s) 140, and one or more network interface(s) 142. The one or more memory devices 138 may be any suitable memory devices, for example, caches, read only memory devices, random access memory devices, magnetic storage devices, etc. The one or more memory devices 138 may store data, executable instructions, and/or various program modules utilized by the financial institution computer 110, for example, data files 144, an operating system 146, a client module 148, a host module 148, and/or a payee prediction module 152. The data files 144 may include any suitable data that facilitates the provision of online banking services, the identification of payees from one or more cleared items posted to a financial account, and/or the generation of one or more suggestions to enroll the consumer for electronic bill presentment and/or the distribution of payments to an identified payee. For example, the data files 144 may include, but are not limited to, profile information for consumers, consumer preferences, log-in and/or access information for consumers, financial account information, other financial information, information associated with identified payees, information associated with bill presentment and/or payment services, and/or information associated with the EBPP service provider computer 115. The operating system (OS) 146 may be a suitable software module that controls the general operation of the financial institution computer 110. The OS 146 may also facilitate the execution of other software modules by the one or more processors 136, for example, the host module 148, the client module 150, and/or the payee prediction module 152. The host module 148 may be a suitable software module, such as a web server or other host server, that facilitates the establishment of a network session with another network device, such as the consumer computer 105 and/or the EBPP service provider computer 115. In this regard, the host module 148 may facilitate interaction between the financial institution computer 110 and the consumer computer 105. For example, the host module 148 may host an online banking session for the consumer computer 105. The client module 150 may be a suitable software module, such as an Internet browser or other dedicated software, that facilitates the establishment of a network session that is hosted by another network device, such as a network session that is hosted by a host module 166 of the EBPP service provider computer 115. In this regard, the financial institution computer 110 may communicate information to and/or receive information from the EBPP service provider computer 115, such as cleared item information, billing information, and/or bill payment information. Although network sessions between the financial institution computer 110 and the EBPP service provider computer 115 are described as being hosted by the EBPP service provider computer 115, as desired in various embodiments of the invention, a network session between the two entities may be hosted by the financial institution computer 110.

The payee prediction module 152 or payee suggestion module 152 may be a suitable software module that facilitates the identification of one or more payees from cleared items posted to a financial account. For example, the payee prediction module 152 may identify payees from one or more check transactions, converted check transactions, direct debit transactions, and/or debit care transaction. The payee prediction module 152 may additionally be operable to generate suggestions to establish electronic bill presentation and/or bill payment services for one or more identified payees. These bill presentation and/or bill payment services may be provided by the financial institution computer 110 and/or by the EBPP service provider computer 115 as desired in various embodiments of the invention.

In certain embodiments, the financial institution computer 110 may include a suitable web portal that facilitates interaction with consumers. One example of a suitable web portal is a web server hosted by a financial institution, such as a bank. As desired, a consumer may log into the web portal and requests various online banking services. For example, a consumer may review various information associated with transactions made utilizing a financial account, for example, cleared items posted to the account. Various suggestions for additional services, such as bill presentment and/or bill payment services, may also be presented to the consumer via the web portal. In certain embodiments of the invention, the web portal may be hosted by the financial institution computer 110. In other embodiments of the invention, a suitable web portal may be hosted by the EBPP service provider computer 115. Various information may be communicated between the financial institution computer 110 and the EBPP service provider computer 115 via one or more web service calls or other requests for information that are communicated from one entity to the other entity. For example, the financial institution computer 110 may utilize one or more web service calls to request and receive information from the EBPP service provider computer 115 regarding one or more payees for which the EBPP service provider computer 115 supports electronic bill presentment and/or distribution of payments. In this regard, the financial institution computer 110 may present various web sites and/or user interface screens to a consumer that are tailored or branded to the financial institution computer 110 while still including information received from or specific to the EBPP service provider computer 115.

Additionally, as desired in various embodiments, a communication session with the consumer computer 105 that has been established by one entity (e.g., the financial institution computer 110 or the EBPP service provider computer 115) may be passed off to another entity. For example, an online banking communication session with a consumer computer 105 may be established by the financial institution computer 110, and the communication session may be passed off to the EBPP service provider computer 115 by the financial institution computer 110 to facilitate the presentation of one or more suggestions to the consumer and/or the enrollment of the consumer into one or more services provided by the EBPP service provider computer 115.

With continued reference to the financial institution computer 110 of FIG. 1, the one or more I/O interfaces 140 may facilitate communication between the financial institution computer 110 and one or more input/output devices, for example, one or more user interface devices, such as, a display, keypad, mouse or other pointing device, control panel, touch screen display, remote control, microphone, etc. that facilitate user interaction with the financial institution computer 110. In this regard, one or more user preferences and/or commands associated with the operation of the financial institution computer 110 may be received and processed.

The one or more network interfaces 142 may facilitate connection of the financial institution computer 110 to one or more suitable networks, for example, a wide area network, the Internet, a cellular network, any wired network, any wireless network, etc. In this regard, the financial institution computer 110 may receive and/or communicate information to other network components of the system 100, such as the consumer computer 105 and/or the EBPP service provider computer 115.

Additionally, the financial institution computer 110 may include or be in communication with one or more memory devices that include one or more databases 180 that are operable to store data that is utilized in various embodiments of the invention, such as profile information for consumers, consumer preferences, log-in and/or access information for consumer, financial account information, other financial information, information associated with identified payees, information associated with bill presentment and/or payment services, and/or information associated with the EBPP service provider computer 115. The one or more databases 180 may be stored in local memory of the financial institution computer 110, such as in the memory 138 of the financial institution computer 110, and/or by one or more suitable external storage devices, network components, and/or systems that are accessible by the financial institution computer 110. As desired, the financial institution computer 110 may include more or less than the components illustrated in FIG. 1. The financial institution computer 110 illustrated in FIG. 1 is provided by way of example only.

Similar to the financial institution computer 110, the EBPP service provider computer 115 may be any suitable processor-driven device that facilitates interaction with other network devices of the system 100 and/or the provision of various bill presentation and/or bill payment services. For example, the EBPP service provider computer 115 may be a network entity that facilitates the collection of bills for a consumer, the electronic presentation of bills to the consumer, the payment of bills on behalf of the consumer via electronic funds transfers and/or paper drafts, and/or the payment of other payees on behalf of the consumer via electronic funds transfers and/or paper drafts. As desired, the EBPP service provider computer 115 may include any number of special purpose computers or other particular machines, application specific circuits, microcontrollers, personal computers, minicomputers, servers, and the like. These various computers may be associated with an underlying EBPP service provider. In certain embodiments, the operations of the EBPP service provider computer 115 may be controlled by computer-executed or computer-implemented instructions that are executed by one or more processors associated with the EBPP service provider computer 115. The instructions may be embodied in one or more software components as desired in various embodiments of the invention. The execution of the instructions may form a special purpose computer or other particular machine that is operable to facilitate the provision of electronic bill presentment and/or distribution of payments to various payees. In certain embodiments, the execution of the instructions may also form a special purpose computer or other particular machine that facilitates the identification of one or more payees from cleared items posted to a financial account and the generation of one or more suggestions to enroll a customer for bill presentment and/or payment services with respect to an identified payee. The one or more processors that control the operations of the EBPP service provider computer 115 may be incorporated into the EBPP service provider computer 115 and/or in communication with the EBPP service provider computer 115 via one or more suitable networks. In certain embodiments of the invention, the operations and/or control of the EBPP service provider computer 115 may be distributed amongst several processing components.

The EBPP service provider computer 115 may include one or more processors 154, one or more memory devices 156, one or more input/output (“I/O”) interface(s) 158, and one or more network interface(s) 160. The one or more memory devices 156 may be any suitable memory devices, for example, caches, read only memory devices, random access memory devices, magnetic storage devices, etc. The one or more memory devices 156 may store data, executable instructions, and/or various program modules utilized by the EBPP service provider computer 115, for example, data files 162, an operating system 164, a host module 166, and/or a payee prediction module 168. The data files 162 may include any suitable data that facilitates the provision of bill presentment and/or payment services, the identification of payees from one or more cleared items posted to a financial account, and/or the generation of one or more suggestions to enroll the consumer for electronic bill presentment and/or the distribution of payments to an identified payee. For example, the data files 162 may include, but are not limited to, profile information for consumers, consumer preferences, log-in and/or access information for consumers, financial account information, other financial information, information associated with identified payees, information associated with bill presentment and/or payment services, and/or information associated with the financial institution computer 110 or a financial institution associated with the financial institution computer 110. The operating system (OS) 164 may be a suitable software module that controls the general operation of the EBPP service provider computer 115. The OS 164 may also facilitate the execution of other software modules by the one or more processors 154, for example, the host module 166 and/or the payee prediction module 168. The host module 166 may be a suitable software module, such as a web server or other host server, that facilitates the establishment of a network session with another network device, such as the consumer computer 105 and/or the financial institution computer 110. In this regard, the host module 166 may facilitate interaction between the EBPP service provider computer 115 and other network devices. For example, the host module 166 may receive and process various web service calls that are communicated to the host module from the financial institution computer 110. In this regard, the financial institution computer 110 can receive bill presentation and/or payment information from the EBPP service provider computer 115 and utilize that information in the generation of suggestions that are presented to the consumer. As another example, the host module 166 may host a network session for the consumer computer 105 that facilitates the presentation of billing information and/or suggestions to the consumer and/or the receipt of various preferences and/or other input from the consumer. Although not shown in FIG. 1, the EBPP service provider computer 115 may include a client module that facilitates the establishment of a network session that is hosted by another network device, such as a network session that is hosted by the financial institution computer 110.

The payee prediction module 168 or payee suggestion module 168 may be similar to the payee prediction module 152 described above with reference to the financial institution computer 110. In this regard, the payee prediction module 168 may be a suitable software module that facilitates the identification of one or more payees from cleared items posted to a financial account. For example, the payee prediction module 168 may identify payees from one or more check transactions, converted check transactions, direct debit transactions, and/or debit care transaction. The payee prediction module 168 may additionally be operable to generate suggestions to establish electronic bill presentation and/or bill payment services for one or more identified payees.

In certain embodiments, the EBPP service provider computer 115 may include a suitable web portal that facilitates interaction with consumers. One example of a suitable web portal is a web server hosted by a bill presentment and payment service provider, such as a service provider operated by Fiserv, Inc. or CheckFree Corporation. As desired, a consumer may log into the web portal and requests various bill presentment and/or payment services. Based on an identification of payees from one or more cleared items posted to a financial account, various suggestions for additional services, such as bill presentment and/or bill payment services for one or more of the identified payees, may also be presented to the consumer via the web portal.

With continued reference to the EBPP service provider computer 115 of FIG. 1, the one or more I/O interfaces 158 may facilitate communication between the EBPP service provider computer 115 and one or more input/output devices, for example, one or more user interface devices, such as, a display, keypad, mouse or other pointing device control panel, touch screen display, remote control, microphone, etc. that facilitate user interaction with the EBPP service provider computer 115. In this regard, one or more user preferences and/or commands associated with the operation of the EBPP service provider computer 115 may be received and processed.

The one or more network interfaces 160 may facilitate connection of the EBPP service provider computer 115 to one or more suitable networks, for example, a wide area network, the Internet, a cellular network, any wired network, any wireless network, etc. In this regard, the EBPP service provider computer 115 may receive and/or communicate information to other network components of the system 100, such as the consumer computer 105 and/or the financial institution computer 110.

Additionally, the EBPP service provider computer 115 may include or be in communication with one or more suitable memory devices that include one or more databases 185 that are operable to store data that is utilized in various embodiments of the invention, such as profile information for consumers, consumer preferences, log-in and/or access information for consumer, financial account information, other financial information, information associated with identified payees, information associated with bill presentment and/or payment services, and/or information associated with the financial institution computer 110. The one or more databases 185 may be stored in local memory of the EBPP service provider computer 115, such as in the memory 156 of the EBPP service provider computer 115, and/or by one or more suitable external storage devices, network components, and/or systems that are accessible by the EBPP service provider computer 115. As desired, the EBPP service provider computer 115 may include more or less than the components illustrated in FIG. 1. The EBPP service provider computer 115 illustrated in FIG. 1 is provided by way of example only.

With continued reference to FIG. 1, communication between various network components of the system 100 may be facilitated via one or more suitable networks 120. These networks 120 may include a wide variety of different types of networks as desired in various embodiments of the invention, for example, local area networks, wide area networks, the Internet, cellular network, radio frequency networks, Bluetooth enabled networks, Wi-Fi enabled networks, wired networks, wireless networks, and/or any other network capable of communicating data.

Additionally, the system 100 may include any number of payees/billers 170 in communication with one or more other network components of the system 100. The payees/billers 170 may be operable to communicate billing information to one or more other system components, such as the EBPP service provider computer 115 and/or the financial institution computer 110. Additionally, the payees/billers 170 and/or various financial institutions associated with the payees/billers 170 may be operable to receive payments from one or more other network components, such as, the EBPP service provider computer 115 and/or the financial institution computer 110.

With continued reference to FIG. 1, in certain embodiments of the invention, the system 100 may include one or more scrapers 175 that are operable to collect information associated with one or more financial accounts of a consumer. Examples of suitable scrapers include those that are operated by Yodlee™ and CashEdge™. However, in certain embodiments of the invention, suitable scraping technology may be incorporated into the EBPP service provider computer 115 or another network component of the system 100. A scraper 175 may utilize prestored account credentials and/or login information for the consumer in order to access and/or collect information associated with one or more financial accounts of the consumer. For example, the scraper 175 may utilize login information for the consumer to access the financial institution computer 110 and collect information associated with cleared items that are posted to a financial account of the consumer that is maintained by the financial institution computer 110. The scraper 175 may then provide this information to another network entity, such as the EBPP service provider computer 115, for analysis.

Those of ordinary skill in the art will appreciate that the system 100 shown in and described with respect to FIG. 1 is provided by way of example only. Numerous other operating environments, system architectures, and device configurations are possible. Accordingly, the invention should not be construed as being limited to any particular operating environment, system architecture, or device configuration. For example, in various embodiments of the invention, any number of consumer, financial institutions, and/or EBPP service providers may be provided. Each of these entities may have any number of respective computers associated with them.

According to an aspect of the invention, information associated with a cleared items history for a financial account of a consumer may be analyzed in order to identify one or more payees for one or more cleared items. One or more suggestions for establishing an identified payee as a payee of the consumer in associated online payment functionality, for activating electronic bill presentment from the identified payee for the consumer, or for establishing recurring payment to the identified payee on behalf of the consumer may be automatically generated as desired and provided to the consumer. In one embodiment, multiple cleared items in a cleared items history may be analyzed in order to generate suggestions for the payee. In another embodiment, a single cleared item may be analyzed. For example, a cleared item may be analyzed when the cleared item is selected by the consumer, and a suggestion may be generated based on the analysis of the cleared item. As desired in various embodiments, generated suggestions and/or partially pre-populated user interface presentations may be communicated and/or presented to the consumer for consideration. The consumer may accept or reject a proposal. Additionally, the consumer may modify presented information and/or provide additional information during an acceptance. In certain embodiments, the acceptance of one proposal may trigger one or more additional or follow-up proposals. For example, the acceptance of a proposal to add a new payee for payment distribution services may trigger a proposal to activate the payee as an electronic biller and/or a proposal to establish recurring payments to the payee.

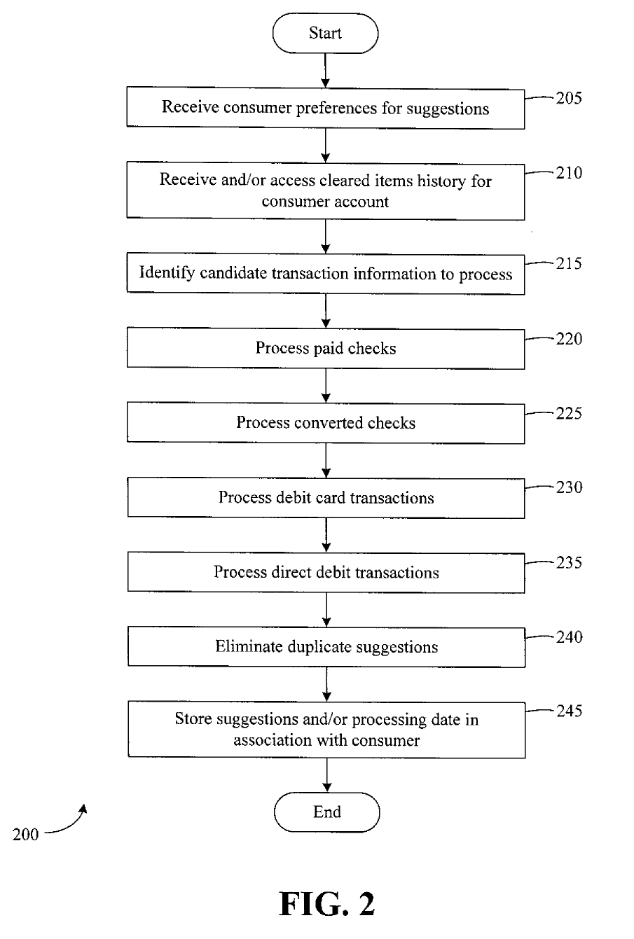

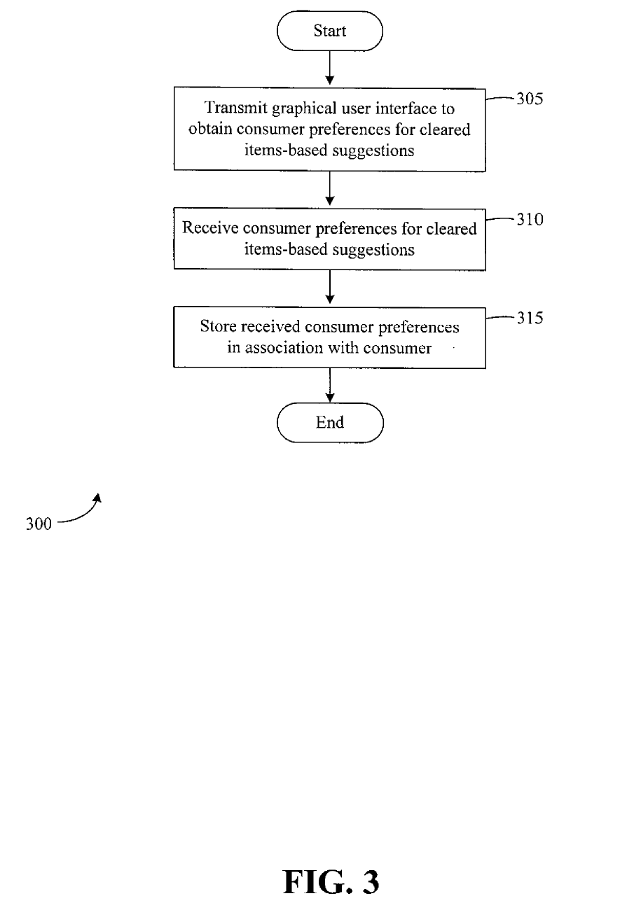

FIG. 2 is a flow chart of an example method 200 for generating payee suggestions for electronic bill presentment and or payment, according to an illustrative embodiment of the invention. The method illustrated in FIG. 2 may identify a payee associated with one or more cleared items posted to a financial account and automatically generate one or more suggestions for activating bill presentment and/or payment distribution services for one or more of the identified payees. The method 200 may be performed by a suitable payee prediction module, such as the payee prediction module 152 of the financial institution computer 110 illustrated in FIG. 1 or the payee prediction module 168 of the EBPP service provider illustrated in FIG. 1. As desired, the method 200 may be performed based on a wide variety of different triggers, for example, a request received from a consumer associated with the financial account, an activity associated with the consumer (e.g., logging in to a web server hosted by the financial institution computer 110 or the EBPP service provider computer 115, accessing financial account information, etc.), and/or various time based triggers. For example, the method 200 may be performed on a periodic basis, for example, once a week, once a month, etc. Parameters associated with the various triggers for performing the method 200 may be default parameters and/or parameters or preferences received from the consumer, as discussed in greater detail below with reference to FIG. 3.

The method 200 may begin at block 205. At block 205, one or more consumer preferences associated with the generation of preferences may be accessed and/or otherwise received. The consumer preferences may be accessed from local memory, received from a remote or third party data source, received through an interprocess communication with another entity (e.g., received by the financial institution computer 110 from the EBPP servie provider computer 115), and/or received from the consumer. A wide variety of different types of consumer preferences and/or parameters may be utilized as desired in various embodiments of the invention, including but not limited to, preferences associated with the scope of cleared items and/or transactions that are processed, preferences associated with the scope of suggestions that are generated for presentation to the consumer, and/or preferences associated with a frequency of processing cleared items and/or transactions. In certain embodiments, parameters and/or preferences associated with a frequency of processing may be examined at block 205, and a determination may be made as to whether cleared items should be analyzed or processed. If it is determined that cleared items should be processed, then operations may continue at block 210. If, however, it is determined that cleared items should not be processed, then the method may end.

Examples of parameters associated with the scope of cleared items include any suitable parameters that facilitate determining which cleared items and/or transactions are analyzed when generating various suggestions. In some embodiments, parameters may relate to various transaction types that are posted to a financial account. For example, consumer preferences may be provided as to whether check transactions, converted check transactions, direct debit transaction, and/or debit card transactions will be analyzed when generating various suggestions. Consumer parameters relating to the scope of cleared items may also be associated with other factors, such as a merchant type associated with a transaction, an amount associated with a transaction, or a date associated with a transaction. For example, a consumer may specify that retail transactions and/or gas station transactions will not be analyzed. In some embodiments, merchant identifiers and/or merchant type identifiers posted to the financial account may be utilized to parse out transactions that are not to be analyzed. As another example, a consumer may specify that transactions below a certain amount, such as transactions below twenty dollars, will not be analyzed. As yet another example, a consumer may specify that transactions that predate a certain period of time, such as transaction older than a month, will not be analyzed. A wide variety of consumer parameters associated with the scope of transactions may be utilized as desired in various embodiments of the invention, and the examples provided above should not be construed as limiting. In the absence of consumer parameters and/or preferences, default parameters may be utilized as desired. For example, default parameters may indicate that check transactions, converted check transactions, direct debit transaction, and/or debit card transactions will be analyzed.

Examples of parameters associated with the scope of suggestions may include any suitable parameters that facilitate the generation and/or presentation of suggestions to a consumer. In some embodiments, the consumer parameters may relate to the types of suggestions that are generated for presentation to the consumer. For example, a consumer may specify whether they wish to receive suggestions for new payees, new electronic billers, and/or recurring payments. Consumer parameters associated with the scope of suggestions may also relate to the particular payees that are identified and/or a history of suggestions made for the particular payees. For example, a consumer may specify that certain suggestions not be generated for a payee if an identical or similar suggestion for that payee was previously declined by the consumer or previously declined by the consumer during a specified period of time, such as within the last month or last three months. A wide variety of consumer parameters associated with the scope of suggestions may be utilized as desired in various embodiments of the invention, and the examples provided above should not be construed as limiting. In the absence of consumer parameters and/or preferences, default parameters may be utilized as desired. For example, default parameters may indicate that new payee suggestions, new electronic biller suggestions, and/or new recurring payment suggestions be generated.

Examples of parameters associated with a frequency of processing may be any suitable parameters that indicate or specify a timing for analyzing cleared items in order to identify payees and generate suggestions. The timing for analyzing cleared items may be associated with a wide variety of different triggers, such as logins to a financial institution or an EBPP service provider by the consumer, the posting of a certain number of cleared items to a financial account, an expected volume of cleared items posted to a financial account, and/or the passage of a time interval. As one example, cleared items may be examined when a consumer logs in to a web site hosted by a financial institution or an EBPP service provider or based on a number of times that the consumer logs in. For example, cleared items may be examined every fifth time, tenth time, etc. that the consumer logs in. As another example, once a predetermined number of cleared items, such as twenty items, fifty items, etc., has been posted to a financial account, the cleared items may be analyzed. As yet another example, cleared items may be analyzed once a week, once every two weeks, once a month, once every six months, etc., and suggestions may be generated based upon the analysis of the cleared items. In the absence of consumer parameters and/or preferences, default parameters for frequency of processing may be utilized as desired. For example, default parameters may indicate that cleared items will be analyzed once a week. In certain embodiments, the processing for a plurality of consumers may be spread or balanced across an analysis period in order to balance the processing load and/or requirements. For example, a consumer base may be divided into seven groups and cleared items for the consumers of each group may be analyzed on respective days of the week.

At block 210, a cleared items history associated with a financial account may be accessed and/or received. The cleared items history may be accessed or received from one or more local memory devices, from one or more remote memory devices, or from one or more third party data sources. The cleared items history may be obtained through either a “push” form of interprocess communication initiated by a third party, such as a file transfer or message queue post, or a “pull” form of interprocess communication by a receiving entity, such as a web service call. For example, a financial institution computer 110 may access a cleared items history from a local memory. As another example, a EBPP service provider computer 115 may receive a cleared items history from a financial institution computer 110 or from a scraper. In certain embodiments, the cleared items history may be accessed and/or received in accordance with consumer parameters and/or default parameters. For example, a cleared items history for a predetermined period of time (e.g., the last week, the last month, the last ninety days, a period of time since the last access of cleared items history) and/or for a predetermined number of transactions may be accessed and/or received in accordance with consumer parameters and/or default parameters. As desired, the cleared items history information may be further filtered in accordance with previous analysis that has been completed. For example, cleared items that were posted prior to a last analysis of cleared items and, therefore, considered during a prior analysis, may be filtered out.

At block 215, the accessed and/or received cleared items history may be filtered to identify candidate information to be further processed. In certain embodiments, the filtering may be based at least in part on consumer preferences. The filtering may facilitate the removal of cleared items and/or transaction information that will not be further processed by the system. Examples of cleared items that may be filtered out include deposits and/or credits to a financial account, automatic teller machine (ATM) or bank teller withdrawals, financial institution or bank fees, online payments, and/or cleared items that are filtered out in accordance with consumer preferences. Online payments may include payments that are made to one or more payees by a suitable payment service provider, such as an EBPP provider associated with the EBPP service provider computer 115 or a financial institution associated with the financial institution computer 110 and working in conjunction with the EBPP service provider computer 115. Once cleared items that are not to be analyzed are filtered out, the remaining cleared items may be further processed. As an alternative to filtering out cleared items that are not to be analyzed, cleared items that will be analyzed, such as check transactions, automatic check transactions, direct debit transaction, and/or debit card transactions, may be identified.

In certain embodiments, the cleared items to be filtered out may be identified by various information associated with the items that is posted for the financial account. For example, credits may be identified via an item type of credit that is posted to the financial account. As another example, withdrawals may be identified by a suitable text string in the item description, such as a text string of “withdrawal.” As another example, online payment may be identified by a suitable text string in the item description, such as a text string of “online pmt.” Various text strings that are identified may vary as desired in various embodiments of the invention. For example, different financial institutions may utilize different text strings when posting items to a financial account. As desired, the text strings to be searched for may be stored and accessed from one or more suitable memory devices, such as a data repository associated with the financial institution computer 110.

As an alternative to identifying online payments by identifying a particular text string in an item description, information associated with a consumer's payees may be accessed or obtained from the EBPP service provider computer 115 or from a memory associated with the EBPP service provider computer 115. For example, a financial institution computer 110 may obtain information associated with a consumer's payees one or more suitable web service calls. The payee designations in cleared items may be compared to a list of the consumer's payees at the EBPP service provider computer 115. Upon a match, a cleared item may be assumed to be an online payment or, at the very least, assumed to not be a candidate for a suggestion. The cleared item may then be filtered out and not processed further.

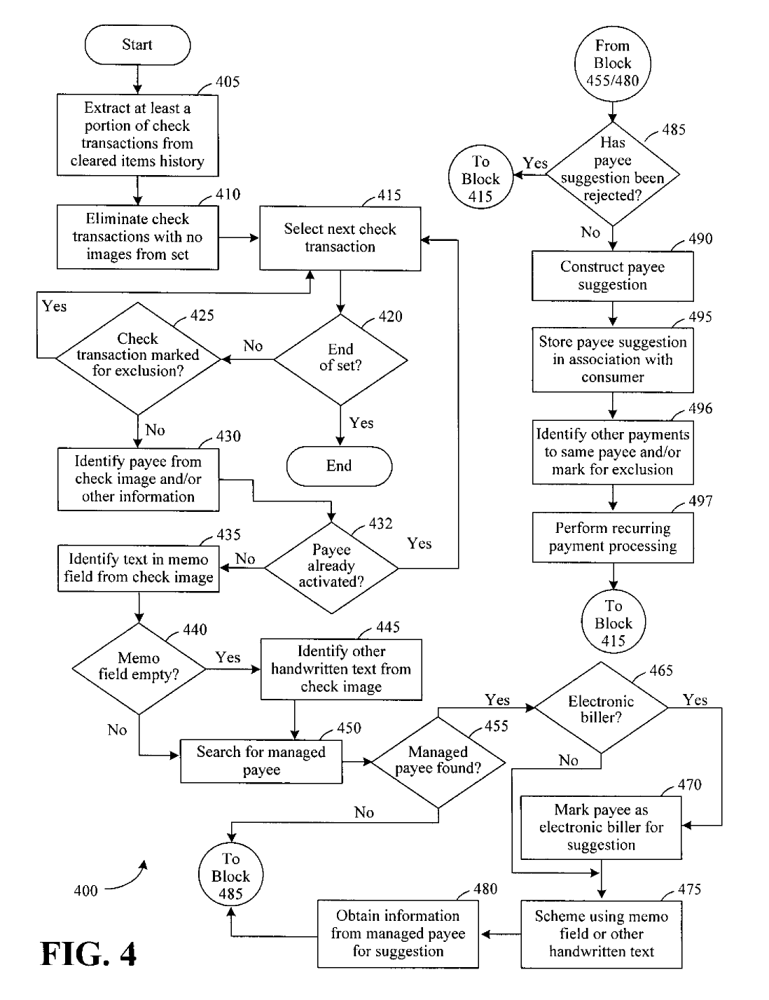

At block 220, one or more cleared check transactions may be processed. During the processing of one or more cleared check transactions, one or more payees associated with the check transactions may be identified. Additionally, one or more suggestions for activating or enrolling the consumer in various services for the payee, such as electronic bill presentment and/or payment distribution services, may be generated for presentation to the consumer. The operations for processing check transactions are discussed in greater detail below with reference to FIG. 4. In certain embodiments of the invention, the operations of block 220 may be optional. For example, if one or more consumer preferences indicate that check transactions are not to be analyzed, then the operations of block 220 may not be performed. Following the processing of check transactions at block 220, operations may continue at block 225.

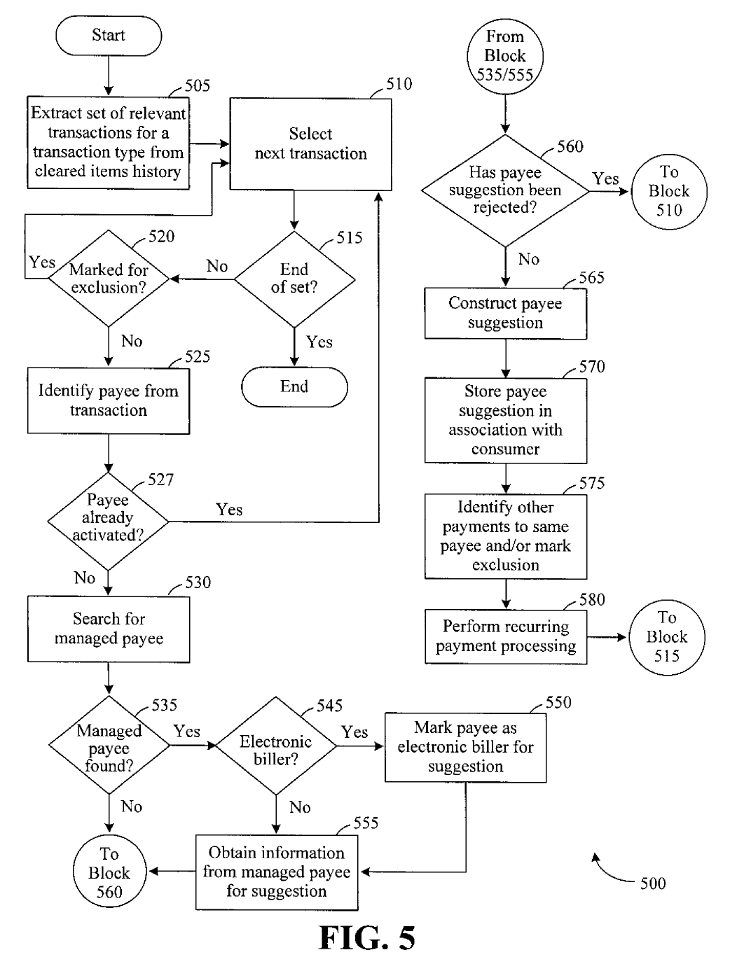

At block 225, one or more converted check transactions may be processed. Converted check transactions may include check transactions in which an image associated with a check is not available. For example, converted check transactions may include check transactions that have been converted into Automated Clearing House (ACH) transactions by a suitable conversion process, such as an accounts receivable conversion (ARC) process or a back office conversion (BOC) process. During the processing of one or more converted check transactions, one or more payees associated with the converted check transactions may be identified. Additionally, one or more suggestions for activating or enrolling the consumer in various services for the payee, such as electronic bill presentment and/or payment distribution services, may be generated for presentation to the consumer. The operations for processing converted check transactions are discussed in greater detail below with reference to FIG. 5. In certain embodiments of the invention, the operations of block 225 may be optional. For example, if one or more consumer preferences indicate that converted check transactions are not to be analyzed, then the operations of block 225 may not be performed. Following the processing of converted check transactions at block 225, operations may continue at block 230.

At block 230, one or more debit card transactions may be processed. During the processing of one or more debit card transactions, one or more payees associated with the debit card transactions may be identified. Additionally, one or more suggestions for activating or enrolling the consumer in various services for the payee, such as electronic bill presentment and/or payment distribution services, may be generated for presentation to the consumer. The operations for processing debit card transactions are discussed in greater detail below with reference to FIG. 5. In certain embodiments of the invention, the operations of block 230 may be optional. For example, if one or more consumer preferences indicate that debit card transactions are not to be analyzed, then the operations of block 230 may not be performed. Following the processing of debit card transactions at block 230, operations may continue at block 235.

At block 235, one or more direct debit transactions may be processed. During the processing of one or more direct debit transactions, one or more payees associated with the direct debit transactions may be identified. Additionally, one or more suggestions for activating or enrolling the consumer in various services for the payee, such as electronic bill presentment and/or payment distribution services, may be generated for presentation to the consumer. The operations for processing direct debit transactions are discussed in greater detail below with reference to FIG. 5. In certain embodiments of the invention, the operations of block 235 may be optional. For example, if one or more consumer preferences indicate that direct debit transactions are not to be analyzed, then the operations of block 235 may not be performed. Following the processing of direct debit transactions at block 235, operations may continue at block 240.

At block 240, generated suggestions may be analyzed and duplicate suggestions may be eliminated and/or consolidated. At block 245, the generated suggestions may then stored in a suitable memory for subsequent communication to and/or presentation to the consumer. The memory may be, for example, a memory associated with the financial institution computer 110, a memory associated with the EBPP service provider computer 115, and/or memory associated with another data source. As desired, the generated suggestions may be stored in association with the consumer, for example, stored in association with a consumer identifier or in a dedicated memory location or memory block associated with the consumer. In this regard, the generated suggestions may be subsequently accessed for communication to the consumer. In addition to storing the generated suggestions, a processing date associated with the analysis of the cleared items history may be stored in association with the consumer. The processing date may be utilized for a wide variety of purposes, for example, to determine a time interval since the last processing of cleared items and/or to identify later posted cleared items that have not been analyzed during subsequent processing. As an alternative to storing generated suggestions, the one or more generated suggestions may be communicated directly to the consumer via an established communications session or via any other suitable communications technique, such as electronic mail, short message service (SMS) messaging, etc.

The method 200 may end following block 245.

The operations described and shown in the method 200 of FIG. 2 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 2 may be performed.

FIG. 3 is a flow chart of an example method 300 for obtaining consumer preferences or parameters associated with the identification of payees for payee suggestions, according to an example embodiment of the invention. As set forth above with reference to FIG. 2, a wide variety of consumer preferences and/or parameters may be utilized in accordance with various embodiments of the invention. These preferences may be stored in a suitable memory associated with an entity that maintains data associated with the consumer or an entity that generates suggestions in accordance with various embodiments of the invention, for example, the financial institution computer 110 illustrated in FIG. 1 and/or the EBPP service provider computer 115 illustrated in FIG. 1. For example, these preferences may be stored in a consumer profile or in other dedicated memory. These preferences may then be accessed during the processing of a cleared items history.

As desired in various embodiments of the invention, consumer preferences may be received via one or more communications, such as web pages and/or other graphical user interfaces, that prompt the consumer to enter one or more preferences. For example, the financial institution computer 110 or the EBPP service provider computer 115 may present one or more web pages to the consumer, and the consumer may enter or select one or more preferences by entering information into a web page and/or by selecting options presented by a web page. In certain embodiments, consumer preferences may be received using forms of communication other than web pages and/or established network sessions. For example, consumer preferences may be received via electronic mail, via SMS messaging, via telephone by a service representative, via snail mail, etc.

FIG. 3 describes an example method 300 for soliciting and/or receiving consumer preferences for cleared items-based suggestions, according to an illustrative embodiment of the invention. The method 300 may begin at block 305. At block 305, a graphical user interface, such as a web page, may be transmitted or otherwise communicated to a consumer processor, such as the consumer computer 105 illustrated in FIG. 1. The graphical user interface may include one or more prompts and/or selections for receiving consumer preferences. The graphical user interface may be communicated to the consumer from a service provider, such as the financial institution computer 110 or the EBPP service provider computer 115, via one or more suitable networks, such as the one or more suitable networks 120 illustrated in FIG. 1.

A graphical user interface for obtaining consumer preferences may be communicated to a consumer at a wide variety of different points in time as desired in various embodiments of the invention. For example, a graphical user interface for obtaining consumer preferences may be communicated to a consumer when the consumer enrolls for electronic banking services. As another example, the graphical user interface may be communicated to the consumer based on the receipt of a consumer request. As yet another example, the graphical user interface may be periodically communicated to the consumer based on, for example, a number of logins into an electronic banking service by the consumer (e.g., every login, every fifth login, etc.) and/or a passage of a predetermined period of time (e.g., once a week, once a month, once every three months, etc.).

The graphical user interface may facilitate the collection of consumer preferences from the consumer. For example, the consumer may enter information associated with preferences into the graphical user interface. Additionally and/or alternatively, the consumer may select various preferences from options that are provided to the consumer in the graphical user interface. Once one or more preferences are entered and/or selected by the consumer, the consumer preferences may be transmitted or otherwise communicated back to the service provider (e.g., financial institution computer 110 or EBPP service provider computer 115) that communicated the graphical user interface to the consumer. The preferences may be transmitted via the one or more suitable networks 120. The preferences may be received by the transmitting entity at block 310. The preferences may then be stored in one or more suitable memory devices at block 315. In certain embodiments, the preferences may be stored for subsequent access by a suitable payee prediction module. A wide variety of memory devices may be utilized as desired, such as local memory devices, remote memory devices, and/or memory devices associated with third party data storage systems or entities.

The method 300 may end following block 315.

The operations described and shown in the method 300 of FIG. 3 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 3 may be performed.

FIG. 4 is a flow chart of an example method 400 for identifying payees from check transactions for payee suggestions, according to an example embodiment of the invention. The method 400 illustrated in FIG. 4 may be carried out by one or more suitable payee prediction modules, for example, payee prediction module 152 or payee prediction module 168 shown in FIG. 1. The method 400 may facilitate the identification of a payee for a check transaction. The method 400 may further determine one or more suggestions associated with the identified payee that may be generated for presentation to the consumer.

The method 400 may begin at block 405. At block 405, at least a portion of the check transactions included in a received cleared items history may be identified and extracted from the cleared items history. One or more suitable identifiers associated with the check transactions, such as a text string of “CHECK” included in the item description, may be recognized in order to facilitate the identification of the check transactions. Once the check transactions have been identified and extracted at block 405, operations may continue at block 410.

At block 410, which may be optional in certain embodiments of the invention, check transactions that do not include a check image may be identified and eliminated. In certain embodiments of the invention, the processing of these types of check transactions may be completed in accordance with the method 500 described below with reference to FIG. 5. As an alternative to identifying and eliminating check transactions that do not include a check image, check transactions that include a check image may be identified for further processing. Once the check transactions that do not include a check image have been removed or eliminated, the remaining check transactions may be further processed in accordance with the method 400. For purposes of describing the method, the remaining check transactions that are further processed may be referred to as the “set of check transactions.”

During the processing of the set of check transactions, one or more of the check transactions may be analyzed. In certain embodiments, check transactions may be analyzed in a serial manner. In other embodiments, two or more check transactions may be analyzed in parallel. For purposes of describing FIG. 4, it will be assumed that the set of check transactions is analyzed in a serial manner. At block 415, a next check transaction may be selected from the set of check transactions. For example, a pointer may be set to the next check transaction in the set of check transactions. At the outset of analyzing the set of check transactions, the pointer may be set to point at the first check transaction. The pointer may be iterated following the analysis of a check transaction such that the pointer is set to point at the next transaction. In this regard, a loop may be utilized to analyze each of the checks in the set of check transactions. For purposes of describing FIG. 4, a check transaction that is being processed may be referred to as a current check transaction.

At block 420, a determination may be made as to whether all of the check transactions in the set of check transactions have been analyzed or otherwise examined. In other words, a determination may be made as to whether the end of the set of check transactions has been reached. If it is determined at block 420 that the end of the set of check transactions has been reached, then the method 400 may end. If, however, it is determined at block 420 that the end of the set of check transactions has not been reached, then operations may continue at block 425.

At block 425, which may be optional in certain embodiments of the invention, a determination may be made as to whether the current check transaction has been marked for exclusion from processing. A check transaction may be marked for exclusion from processing if another transaction with the same payee has previously been processed. For example, during the processing of check transactions, converted check transactions, direct debit transactions, and/or debit card transactions, once a payee has been identified, other transactions with the same payee may be identified and marked for exclusion. When a transaction is marked for exclusion, subsequent processing of the check transaction may be limited. As an alternative, to marking check transactions and other transactions for exclusion, once a payee has been identified for a first transaction, other transactions with the same payee may be removed from a set of transactions to be analyzed.

If it is determined at block 425 that the current check transaction has been marked for exclusion, then operations may continue at block 415 and the next check transaction in the set of check transactions may be selected. If, however, it is determined at block 425 that the current check transaction has not been marked for exclusion, then operations may continue at block 430.

At block 430, the payee of the current check transaction may be identified. In certain embodiments, the payee of the current check transaction may be identified from the check image associated with the current check transaction. Any number of suitable data recognition techniques, software programs, and/or systems may be utilized to facilitate the recognition and/or interpretation of printed and/or handwritten data within a scanned check image that identifies the payee. For example, intelligent character recognition (ICR) or optical character recognition (OCR) techniques may be utilized. As desired in various embodiments of the invention, a portion or all of the check image may be examined or analyzed in order to identify the payee. For example, a portion of the check image that is examined may be constrained to one or more areas associated with a typical location of a payee line.

In addition to or as an alternative to identifying the payee from the check image, the payee of the check transaction may be identified from any other suitable information included in the cleared items history for the check transaction. For example, the cleared items history may include an item description field for the check transaction, and the payee may be identified from information included in the item description field. Once the payee of the current check transaction has been identified, operations may continue at block 432.

At block 432, a determination may be made as to whether the identified payee has already been activated as a payee of the consumer for one or more services provided by a service provider, such as the financial institution computer 110 or the EBPP service provider computer 115. For example, a determination may be made as to whether electronic bill presentment services and/or payment distribution services have already been activated for the identified payee. If it is determined at block 432 that the identified payee has already been activated, then operations may continue at block 415 and the next check transaction may be selected for analysis. If, however, it is determined at block 432 that the identified payee has not been activated for one or more services, then operations may continue at block 435.

At block 435, at least a portion of any text included in the memorandum or memo field of the check image may be identified. In certain embodiments of the invention, it may be assumed the text included in the memo field of a check image includes an account number of the consumer at the payee. Similar to identifying the payee from the check image, any number of suitable data recognition techniques, software programs, and/or systems may be utilized to facilitate the recognition and/or interpretation of printed and/or handwritten data included in the memo field of the check image. Additionally, as desired, a portion of the check image that is examined may be constrained to one or more areas associated with a typical location of a memo field or memo line.

At block 440, a determination may be made as to whether the memo field is empty and/or whether information included in the memo field is unrecognizable. If it is determined at block 440 that the memo field is not empty and/or that information included in the memo field is recognizable, then operations may continue at block 450. If, however, it is determined at block 440 that the memo field is empty or that information included in the memo field is unrecognizable, then operations may continue at block 445.

At block 445, other text included in the check image may be identified. For example, other handwritten and/or printed text included in the check image may be identified utilizing any number of suitable data recognition techniques, software programs, and/or systems. In this regard, an account number that is included on the check somewhere other than the memo line may be identified. In certain embodiments, one or more portions of the check, such as portions in an upper area of the check that are separate from typical check information (e.g., bank information, consumer information, payee information, check number, date, courtesy amount, legal amount, payee, signature, etc.), may be examined for printed and/or handwritten text information. If any text is identified, the text may be captured in a similar manner as that utilized to capture text at block 430. Following the identification and/or capture of text at block 445, operations may continue at block 450.

In certain embodiments of the invention, other text included in the check image may be identified even if it is determined at block 440 that the memo field is not empty. For example, it may be determined that the information included in the memo field does not include an account number for the consumer at the payee. As a result of this determination, other text included in the check image may be identified in an attempt to determine an account number for the consumer at the payee.

At block 450, one or more memory devices and/or associated data repositories that include information associated with managed payees may be searched for the identified payee. A managed payee may be a payee about whom a service provider, such as the financial institution computer 110 or the EBPP service provider computer 115, has information that enables a remittance or payment to that payee to be handled in some improved or optimal fashion. The information may include, but is not limited to, account schemes for improved reliability of accounts receivable posting at the managed payee, account ranges for remittance center identification, other information for remittance center identification, payee preferred payment form (paper or electronic), payee preferred remittance advice form (paper or electronic, and format/syntax), and electronic communication parameters for delivery of electronic credits and/or electronic remittance advice. As desired, the information associated with a managed payee may facilitate the generation of suggestions associated with the managed payee.

The data repositories that are searched may include local data repositories and/or remote data repositories. For example, information that is stored in a data repository at the financial institution computer 110 may be searched. As another example, the financial institution computer 110 may request and/or receive managed payee information from the EBPP service provider computer 115, such as through one or more web service calls, and the managed payee information may be searched for the identified payee. As yet another example, the financial institution computer 110 may communicate information associated with the identified payee to the EBPP service provider computer 115 or another entity along with a request to search managed payee information for the identified payee. A search for the identified payee may be conducted by the EBPP service provider or other entity, and an indication of whether the identified payee is a managed payee may be returned to the financial institution computer 110.

A wide variety of suitable methods and/or techniques may be utilized as desired to facilitate the search for the identified payee in the data repository of managed payees. For example, a search may be conducted utilizing the name of the identified payee as a search parameter. As another example, a search may be conducted utilizing a normalized version of the name of the identified payee. The normalization may be conducted utilizing any number of suitable normalization rules as desired in various embodiments of the invention, such as rules that truncate the name of the identified payee to a common name for the payee. As yet another example, multiple searches may be conducted utilizing any number of likely variants of the name of the identified payee.

At block 455, a determination may be made as to whether the identified payee corresponds to a managed payee. In other words, a determination may be made as to whether information associated with the identified payee is stored in a data repository for managed payees. As desired, the determination may include a certainty scoring analysis. For example, a determination may be made as to whether the certainty of a payee being a managed payee is above a predetermined certainty threshold, and the payee may be identified as a managed payee if the certainty satisfies the certainty threshold. If it is determined at block 455 that the identified payee does not correspond to a managed payee, then operations may continue at block 485. If, however, it is determined at block 455 that the identified payee corresponds to a managed payee, then operations may continue at block 465.

At block 465, which may be optional in certain embodiments, a determination may be made as to whether the identified payee is an electronic biller in addition to being a managed payee. In other words, a determination may be made as to whether the identified payee supports the transmission or communication of electronic billing information, such as electronic bill summaries and/or detailed electronic bills, to a service provider (e.g., financial institution computer 110, EBPP service provider computer 115, etc.) for presentation to the consumer. In certain embodiments, the determination of whether the identified payee is an electronic biller may be made based at least in part on consumer preferences and/or parameters. For example, if a consumer preference specifies that the consumer does not wish to receive suggestions to activate electronic bill presentment, then the determination at block 465 may not be performed. If it is determined at block 465 that the identified payee is not an electronic biller, then operations may continue at block 475. If, however, it is determined at block 465 that the identified payee is an electronic biller, then operations may continue at block 470. At block 470, the identified payee may be marked as an electronic biller. The marking of the payee as an electronic biller may facilitate the generation of one or more suggestions to activate electronic bill presentment services for the payee. Following the marking of the payee as an electronic biller, operations may continue at block 475.

At block 475, one or more attempts may be made to scheme any potential account number for the consumer at the identified payee. For example, attempts may be made to scheme text extracted from the memo field or another portion of a check image. The attempts to scheme text may facilitate determining whether the text includes a potential account number for the consumer at the identified payee and/or altering a potential account number to satisfy a required account number format for the payee. As desired in various embodiments of the invention, any number of suitable methods and/or techniques may be utilized in an attempt to scheme text that may be associated with a potential account number for the consumer. For example, the text may be compared to one or more rules associated with the proper formatting of an account number for the identified payee obtained, for example, from information associated with the managed payee. A determination may be made as to whether a potential account number satisfies the formatting requirements of an account number for the payee. Additionally or alternatively, the scheming of a potential account number may facilitate certain alteration of the potential account number in order to generate an account number that satisfies formatting requirements of the payee. For example, one or more alphanumeric characters that are typically included in an account number for the payee, such as one or more characters at the beginning or end of an account number, may be added to the potential account number during the scheming.

If text extracted from the check image is successfully schemed at block 475, then the identified account number and/or an altered account number (also referred to as the “before” and “after” versions of the account number) may be added to information that is being assembled for the generation of one or more suggestions to be presented to the consumer. Operations may then continue at block 480. At block 480, which may be optional in certain embodiments of the invention, information from the managed payee may be obtained for use in generating suggestions. A wide variety of information from the managed payee may be obtained as desired in various embodiments of the invention, including but not limiting to, preferred payee name, preferred payee (or payee remittance center) address, payee customer support telephone number, etc. As desired, the information from the managed payee may be obtained from one or more local memory devices, from one or more remote storage devices, from one or more other network entities, from one or more third party data sources, and/or directly from the payee. In certain embodiments, data from the managed payee may be requested and/or received via one or more suitable networks, such as the networks 120 illustrated in FIG. 1. For example, data from the managed payee may be requested and/or received using one or more suitable web service calls that are communicated to the payee, to the EBPP service provider computer 115, and/or to another entity. Once information from the managed payee is obtained, operations may continue at block 485.

At block 485, which may be optional in certain embodiments of the invention, a determination may be made as to whether any suggestions for the identified payee have previously been rejected by the consumer. For example, one or more consumer preferences may specify that the consumer does not wish to receive suggestions or certain types of suggestions for particular payees. As another example, one or more consumer preferences may specify that the consumer does not wish to receive suggestions or certain types of suggestions for a payee for a predetermined period of time (e.g., three months, six months, one year, etc.) or indefinitely once a suggestion has been declined or rejected by the consumer. If it is determined at block 485 that one or more suggestions for the identified payee have not previously been rejected, then operations may continue at block 490. If, however it is determined at block 485 that one or more suggestions for the identified payee have previously been rejected by the consumer, then operations may continue at block 415 and the next check transaction may be selected for processing. Alternatively, additional processing may be conducted as desired in various embodiments to determine whether suggestions should be presented to the consumer for the identified payee. For example, a determination may be made as to whether particular types of suggestions may be presented to the consumer based on consumer preferences. Other determinations for presenting suggestions may be made as desired based at least in part on one or more consumer preferences. If it is determined that suggestions or certain types of suggestions may be presented to the consumer, then operations may continue at block 490.

At block 490, one or more suggestions for the identified payee may be generated or constructed. As desired, the suggestions may relate to establishing the payee for one or more services provided by a service provider, such as the EBPP service provider computer 115, for the consumer. For example, a suggestion may be generated indicating that the payee may be added as a payee of the consumer to enable payments to be submitted to the identified payee on behalf of the consumer by the service provider. These payments may be, for example, electronic payments and/or paper instruments. As another example, a suggestion may be generated indicating that the payee may be activated to deliver billing information for electronic presentment to the consumer through the service provider. The suggestions described above are provided by way of example only. Other types of suggestions may be generated as desired in various embodiments of the invention.

At block 495, one or more generated payee suggestions may be stored in association with the consumer in one or more suitable memory devices and/or associated data repositories, such as databases 175 or databases 180 illustrated in FIG. 1. As one example, the one or more suggestions may be stored in local memory. As another example, the one or more suggestions may be stored in a memory associated with another network device by one or more web service calls. For example, a suggestion may be generated by the EBPP service provider computer 115 and stored in a memory associated with the financial institution computer 110. When the consumer logs into a web portal provided by the financial institution computer 110, such as an electronic banking web portal, the suggestion may be presented to the consumer. As another example, a suggestion may be generated by the financial institution computer 110 and stored in a memory associated with the EBPP service provider computer 115. When the consumer logs into a web portal provided by the EBPP service provider computer 115 and, such as a bill presentation and/or payment web portal, the suggestion may be presented to the consumer.

At block 496, other transactions included in the cleared items history may be searched and/or examined in order to identify transactions with the same payee. The other transactions that are searched may include other check transactions and/or other types of transactions as desired. Transactions that include the same payee may be marked for exclusion. A wide variety of suitable methods may be utilized as desired to identify other transactions or payment made to the same payee. For example, a loop may be utilized to analyze the transactions that have not already been processed. During the processing of each transaction, the payee of the transaction may be identified. The identified payee may be compared to the payee for the current check transaction. If the identified payee is the same as the payee for the current check transaction, then the transaction may be marked for exclusion. Additionally, as desired, information associated with the transaction may be marked and/or stored for subsequent recurring payment processing.

During the comparison of an identified payee for a transaction to the payee of the current check transaction, it is not necessary that the two payees match exactly. Instead, the payees may be found to correspond even if they are not exactly equivalent. A wide variety of comparison techniques and/or fuzzy logic may be utilized as desired to facilitate the comparison of the payees. For example, the payee names may be normalized to facilitate the comparison. As another example, common variants of the payee for the current check transaction may be utilized for the comparison. As yet another example, various fuzzy logic techniques may be utilized in the comparison to facilitate the determination of matches even if one or both of the payee names includes a typographical error. As desired, the determination of a correspondence may include a certainty scoring analysis. For example, a correspondence may be identified based on whether the certainty of a comparison is above a predetermined certainty threshold, and a correspondence may be identified if the certainty of a match satisfies the certainty threshold.

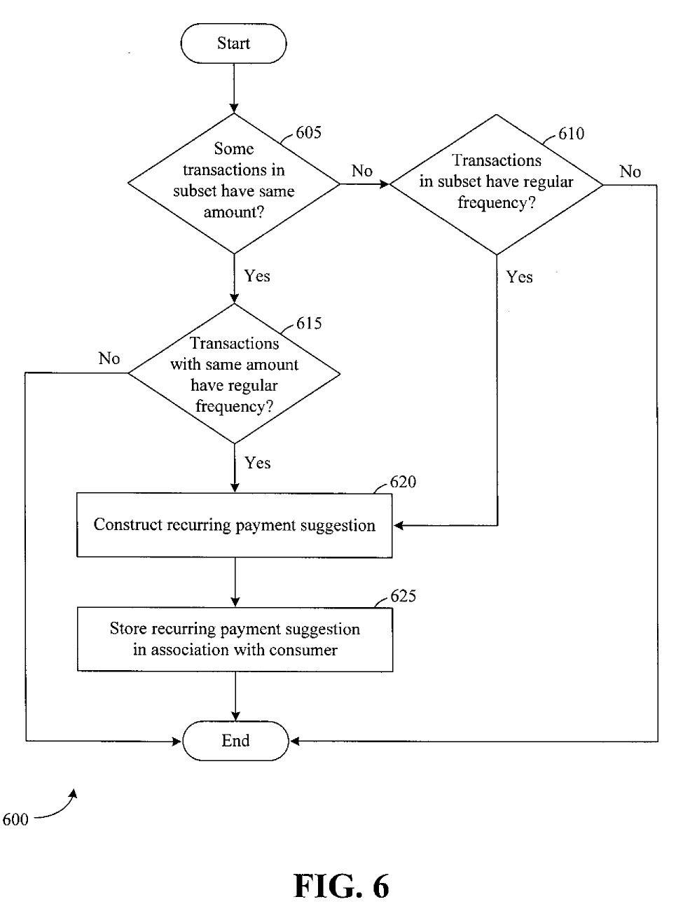

At block 497, which may be optional in certain embodiments of the invention, recurring payment processing may be conducted for the current check transaction. In this regard, multiple payments that are made to the same payee may be analyzed in an attempt to identify one or more patterns associated with the payments made to the payee. Upon the identification or recognition of a pattern, a recurring payment suggestion for the payee may be generated and/or stored for presentation to the consumer. As an example, monthly payments to a mortgage company may be identified and a suggestion for setting up recurring payments to the mortgage company may be generated. A suitable method for conducting recurring payment processing is discussed in greater detail below with reference to FIG. 6.

Following the recurring payment processing at block 497, operations may continue at block 415 and the next check transaction may be selected. Check transactions may be examined in an iterative manner until the set of check transactions has been examined. Once the end of the set has been reached, the method 400 may end.

The operations described and shown in the method 400 of FIG. 4 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 4 may be performed. For example, a determination may be made as to whether the identified payee has already been activated as a payee for one or more services provided by a service provider after a payee has been identified as a managed payee. This determination may be in addition to or alternative to the determination made at block 432.

FIG. 5 is a flow chart of an example method 500 for identifying payees from electronic transactions for payee suggestions, according to an example embodiment of the invention. The method 500 illustrated in FIG. 5 may be carried out by one or more suitable payee prediction modules, for example, payee prediction module 152 or payee prediction module 168 shown in FIG. 1. The method 500 may facilitate the identification of a payee for a transaction, for example, an converted check transaction, a debit card transaction, or a direct debit transaction. The transaction may be a transaction that does not have an image associated with it. The method 500 may further determine one or more suggestions associated with the identified payee that may be generated for presentation to the consumer.

The method 500 illustrated in FIG. 5 may be utilized to process a wide variety of different types of transactions, including but not limited to, converted check transactions, debit card transactions, and/or direct debit transactions. In certain embodiments of the invention, a set of transactions that includes multiple transaction of the same type may be processed together. In other embodiments of the invention, a set of transactions that includes multiple types of transactions may be processed together. For purposes of describing FIG. 5, it will be assumed that a set of transactions of the same type are processed in accordance with the method 500.

The method 500 may begin at block 505. At block 505, at least a portion of the relevant transactions for a transaction type may be identified from a cleared items history and extracted for processing. One or more suitable identifiers associated with the set of transactions, such as a text string included in the item description and/or an item type, may be recognized in order to facilitate the identification of the relevant transactions. For example, an identifier of “point of sale transaction” or “checkcard transaction” may be recognized to identify relevant debit card transactions. As another example, an identifier of “debit” may be recognized to identify relevant direct debit transactions. As yet another example, an identifier of “automated check” may be recognized to identify relevant converted check transactions. A wide variety of identifiers may be recognized as desired in various embodiments of the invention and the examples above are not intended to be limiting. Once the relevant transactions have been identified and extracted at block 505, one or more of the set of relevant transactions may be processed.

During the processing of the set of relevant transactions, one or more of the relevant transactions may be analyzed. In certain embodiments, transactions may be analyzed in a serial manner. In other embodiments, two or more transactions may be analyzed in parallel. For purposes of describing FIG. 5, it will be assumed that the set of relevant transactions is analyzed in a serial manner. At block 510, a next transaction may be selected from the set of relevant transactions. For example, a pointer may be set to the next transaction in the set of transactions. At the outset of analyzing the set of transactions, the pointer may be set to point at the first transaction. The pointer may be iterated following the analysis of a transaction such that the pointer is set to point at the next transaction. In this regard, a loop may be utilized to analyze each of the transactions in the set of relevant transactions. For purposes of describing FIG. 5, a transaction that is being processed may be referred to as a current transaction.

At block 515, a determination may be made as to whether all of the transactions in the set of relevant transactions have been analyzed or otherwise examined. In other words, a determination may be made as to whether the end of the set of relevant transactions has been reached. If it is determined at block 515 that the end of the set of transactions has been reached, then the method 500 may end. If, however, it is determined at block 515 that the end of the set of check transactions has not been reached, then operations may continue at block 520.

At block 520, which may be optional in certain embodiments of the invention, a determination may be made as to whether the current transaction has been marked for exclusion from processing. A transaction may be marked for exclusion from processing if another transaction with the same payee has previously been processed. In some embodiments, the other transaction may be another transaction from the set of relevant transactions being currently processed. For example, during the processing of converted check transactions, direct debit transactions, and/or debit card transactions, once a payee has been identified, other transactions with the same payee may be identified and marked for exclusion. When a transaction is marked for exclusion, subsequent processing of the transaction may be limited. As one example, the transaction may be passed over when it is selected for processing. As another example, certain information may be identified and extracted from the transaction, such as a payment amount and/or date, and the extracted information may be utilized in generating suggestions. For example, payment amounts and/or dates for transactions that have been marked for exclusion may be utilized in the generation of recurring payment suggestions. As an alternative, to marking transactions for exclusion, once a payee has been identified for a first transaction, other transactions with the same payee may be removed from a set of transactions to be analyzed.

If it is determined at block 520 that the current transaction has been marked for exclusion, then operations may continue at block 510 and the next transaction in the set of relevant transactions may be selected. If, however, it is determined at block 520 that the current transaction has not been marked for exclusion, then operations may continue at block 525.

At block 525, the payee of the current transaction may be identified. For example, the information associated with the transaction that is stored in the cleared items history may be analyzed in order to determine the payee for the current transaction. In certain embodiments, the payee may be identified from the item description for the transaction. Once the payee of the current transaction has been identified, operations may continue at block 527. If the payee of the transaction cannot be identified, then operations may continue at block 510 and the next transaction may be selected.

At block 527, a determination may be made as to whether the identified payee has already been activated as a payee for one or more services provided by a service provider, such as the financial institution computer 110 or the EBPP service provider computer 115. For example, a determination may be made as to whether electronic bill presentment services and/or payment distribution services have already been activated for the identified payee. If it is determined at block 527 that the identified payee has already been activated, then operations may continue at block 510 and the next transaction may be selected for analysis. If, however, it is determined at block 527 that the identified payee has not been activated for one or more services, then operations may continue at block 530.

At block 530, one or more data repositories and/or memory devices that include information associated with managed payees may be searched for the identified payee. The data repositories that are searched may include local data repositories and/or remote data repositories. For example, information that is stored in a data repository at the financial institution computer 110 may be searched. As another example, the financial institution computer 110 may request and/or receive managed payee information from the EBPP service provider computer 115, such as through one or more web service calls, and the managed payee information may be searched for the identified payee. As yet another example, the financial institution computer 110 may communicate information associated with the identified payee to the EBPP service provider computer 115 or another entity along with a request to search managed payee information for the identified payee. A search for the identified payee may be conducted by the EBPP service provider or other entity, and an indication of whether the identified payee is a managed payee may be returned to the financial institution computer 110.

A wide variety of suitable methods and/or techniques may be utilized as desired to facilitate the search for the identified payee in the data repository of managed payees. For example, a search may be conducted utilizing the name of the identified payee as a search parameter. As another example, a search may be conducted utilizing a normalized version of the name of the identified payee. The normalization may be conducted utilizing any number of suitable normalization rules as desired in various embodiments of the invention, such as rules that truncate the name of the identified payee to a common name for the payee. As yet another example, multiple searches may be conducted utilizing any number of likely variants of the name of the identified payee.

At block 535, a determination may be made as to whether the identified payee corresponds to a managed payee. In other words, a determination may be made as to whether information associated with the identified payee is stored in a data repository for managed payees. As desired, the determination may include a certainty scoring analysis. For example, a determination may be made as to whether the certainty of a payee being a managed payee is above a predetermined certainty threshold, and the payee may be identified as a managed payee if the certainty satisfies the certainty threshold. If it is determined at block 535 that the identified payee does not correspond to a managed payee, then operations may continue at block 560. If, however, it is determined at block 535 that the identified payee corresponds to a managed payee, then operations may continue at block 545.

At block 545, which may be optional in certain embodiments, a determination may be made as to whether the identified payee is an electronic biller in addition to being a managed payee. In other words, a determination may be made as to whether the identified payee supports the transmission or communication of electronic billing information, such as electronic bill summaries and/or detailed electronic bills, to a service provider (e.g., financial institution computer 110, EBPP service provider computer 115, etc.) for presentation to the consumer. In certain embodiments, the determination of whether the identified payee is an electronic biller may be made based at least in part on consumer preferences and/or parameters. For example, if a consumer preference specifies that the consumer does not wish to receive suggestions to activate electronic bill presentment, then the determination at block 545 may not be performed. If it is determined at block 545 that the identified payee is not an electronic biller, then operations may continue at block 555. If, however, it is determined at block 545 that the identified payee is an electronic biller, then operations may continue at block 550. At block 550, the identified payee may be marked as an electronic biller. The marking of the payee as an electronic biller may facilitate the generation of one or more suggestions to activate electronic bill presentment services for the payee. Following the marking of the payee as an electronic biller, operations may continue at block 555.

At block 555, which may be optional in certain embodiments of the invention, information from the managed payee may be obtained for use in generating suggestions. A wide variety of information from the managed payee may be obtained as desired in various embodiments of the invention, including but not limited to, a preferred payee name, a preferred payee or remittance center address, a customer service telephone number for the payee, etc. As desired, the information from the managed payee may be obtained from one or more local memory devices, from one or more remote storage devices, from one or more other network entities, from one or more third party data sources, and/or directly from the payee. In certain embodiments, data from the managed payee may be requested and/or received via one or more suitable networks, such as the networks 120 illustrated in FIG. 1. For example, data from the managed payee may be requested and/or received using one or more suitable web service calls that are communicated to the payee, to the EBPP service provider computer 115, and/or to another entity. Once information from the managed payee is obtained, operations may continue at block 560.

At block 560, which may be optional in certain embodiments of the invention, a determination may be made as to whether any suggestions for the identified payee have previously been rejected by the consumer. For example, one or more consumer preferences may specify that the consumer does not wish to receive suggestions or certain types of suggestions for particular payees. As another example, one or more consumer preferences may specify that the consumer does not wish to receive suggestions or certain types of suggestions for a payee for a predetermined period of time (e.g., three months, six months, one year, etc.) or indefinitely once a suggestion has been declined or rejected by the consumer. If it is determined at block 560 that one or more suggestions for the identified payee have not previously been rejected, then operations may continue at block 565. If, however it is determined at block 560 that one or more suggestions for the identified payee have previously been rejected by the consumer, then operations may continue at block 510 and the next transaction may be selected for processing. Alternatively, additional processing may be conducted as desired in various embodiments to determine whether suggestions should be presented to the consumer for the identified payee. For example, a determination may be made as to whether particular types of suggestions may be presented to the consumer based on consumer preferences. Other determinations for presenting suggestions may be made as desired based at least in part on one or more consumer preferences. If it is determined that suggestions or certain types of suggestions may be presented to the consumer, then operations may continue at block 565.

At block 565, one or more suggestions for the identified payee may be generated or constructed. As desired, the suggestions may relate to establishing the payee for one or more services provided by a service provider, such as the EBPP service provider computer 115, for the consumer. For example, a suggestion may be generated indicating that the payee may be added as a payee of the consumer to enable payments to be submitted to the identified payee on behalf of the consumer by the service provider. These payments may be, for example, electronic payments and/or paper instruments. As another example, a suggestion may be generated indicating that the payee may be activated to deliver billing information for electronic presentment to the consumer through the service provider. The suggestions described above are provided by way of example only. Other types of suggestions may be generated as desired in various embodiments of the invention.

At block 570, one or more generated payee suggestions may be stored in association with the consumer in one or more suitable memory devices and/or associated data repositories, such as databases 175 or databases 180 illustrated in FIG. 1. As one example, the one or more suggestions may be stored in local memory. As another example, the one or more suggestions may be stored in a memory associated with another network device by one or more web service calls. For example, a suggestion may be generated by the EBPP service provider computer 115 and stored in a memory associated with the financial institution computer 110. When the consumer logs into a web portal provided by the financial institution computer 110, such as an electronic banking web portal, the suggestion may be presented to the consumer. As another example, a suggestion may be generated by the financial institution computer 110 and stored in a memory associated with the EBPP service provider computer 115. When the consumer logs into a web portal provided by the EBPP service provider computer 115 and, such as a bill presentation and/or payment web portal, the suggestion may be presented to the consumer.

At block 575, other transactions included in the cleared items history may be searched and/or examined in order to identify transactions with the same payee. The other transactions that are searched may include other transactions in the set of transactions that are analyzed and/or transactions in other sets of transactions. Transactions that include the same payee may be marked for exclusion. A wide variety of suitable methods may be utilized as desired to identify other transactions or payment made to the same payee. The identification of other transactions with the same payee may be similar to that illustrated in block 496 illustrated in FIG. 4.

At block 580, which may be optional in certain embodiments of the invention, recurring payment processing may be conducted for the current transaction. In this regard, multiple payments that are made to the same payee may be analyzed in an attempt to identify one or more patterns associated with the payments made to the payee. Upon the identification or recognition of a pattern, a recurring payment suggestion for the payee may be generated and/or stored for presentation to the consumer. As an example, monthly payments to a mortgage company may be identified and a suggestion for setting up recurring payments to the mortgage company may be generated. A suitable method for conducting recurring payment processing is discussed in greater detail below with reference to FIG. 6.

Following the recurring payment processing at block 580, operations may continue at block 510 and the next transaction may be selected. Transactions may be examined in an iterative manner until the set of relevant transactions has been examined. Once the end of the set has been reached, the method 500 may end.

The operations described and shown in the method 500 of FIG. 5 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 5 may be performed. For example, a determination may be made as to whether the identified payee has already been activated as a payee for one or more services provided by a service provider after a payee has been identified as a managed payee. This determination may be in addition to or alternative to the determination made at block 527.

FIG. 6 is a flow chart of an example method 600 for identifying recurring payment opportunities, according to an example embodiment of the invention. The method 600 may be carried out by one or more suitable payee prediction modules, for example, payee prediction module 152 or payee prediction module 168 shown in FIG. 1. The method 600 may facilitate the identification of one or more patterns in a subset of transactions that include the same payee. In an example embodiment of the invention, a subset of transactions that include the same payee may be identified, and the identified subset of transactions may be analyzed in accordance with the method 600 illustrated in FIG. 6.

The method 600 may begin at block 605. At block 605, a determination may be made as to whether multiple transactions in the subset of transactions have the same transaction amount. Any suitable number of techniques may be utilized as desired to determine the amount. For example, the amount of the transaction may be identified and extracted from the information associated with the transaction that is included in the cleared items history. As another example, for check transactions, the amount of the check transaction may be recognized and extracted from a check image. If it is determined at block 605 that multiple transactions in the subset of transactions have the same amount, then operations may continue at block 610. If, however, it is determined at block 605 that multiple transactions in the subset of transactions do not have the same amount, then operations may continue at block 615.

At block 610, a determination may be made as to whether multiple transactions in the subject of transactions have a regular frequency. For example, the transaction dates and/or posting dates of various transactions to the same payee may be identified and/or extracted from information included in the cleared items history. The various dates may be analyzed in an attempt to identify a payment frequency or a payment pattern. For example, a determination may be made as to whether payments are submitted to the payee on a weekly basis, bi-weekly basis, monthly basis, three months basis, bi-annual basis, annual basis, etc. As desired, some amount of variation may be permitted to allow for holidays, reasonable variance in consumer payment, etc. In certain embodiments, an acceptable variance threshold may be established based upon the payment frequency that is being tested for. For example, an acceptable variance threshold of one week may be established when testing for monthly payments. If the variation between two payments exceeds the acceptable threshold, then no payment pattern will be detected. If, however, the variation between the payments satisfies the acceptable threshold, then a payment pattern may be detected. For example, if a first mortgage payment is made on March 1^{st} and a second mortgage payment is made on April 3^{rd}, then a monthly payment pattern may be detected. As another example, if a first payment to a payee is made on March 1^{st} and a second payment to the same payee is made on April 23^{rd}, then no monthly payment pattern will be detected.

If it is determined at block 610 that transactions in the subset of transactions do not have a regular frequency, then the method 600 may end. However, if it is determined at block 610 that transactions in the subset have a regular frequency, then operations may continue at block 620 and one or more recurring payment suggestions may be generated or constructed.

At block 615, a determination may be made as to whether multiple transactions in the subject of transactions having the same amount also have a regular frequency. The determination at block 615 of whether multiple transaction have a regular frequency may be similar to the determination made at block 610 for payment that do not necessarily have the same amount. If it is determined at block 615 that transactions with the same amount do not have a regular frequency, then the method 600 may end. However, if it is determined at block 615 that transactions with the same amount have a regular frequency, then operations may continue at block 620 and one or more recurring payment suggestions may be generated or constructed.

At block 620, one or more recurring payment situations may be identified and one or more new recurring payment suggestions may be constructed or generated. The suggestions that are constructed or generated may include, as desired, at least a portion of the information identified during the various determinations made in accordance with the method of FIG. 6, such as, a transaction amount and/or a frequency. For example, situations in which payments are made to the same payee with a regular frequency may be identified, and a suggestion for submitting recurring payments to the payee on behalf of the consumer may be generated for presentation to the consumer. A recurring payment suggestion may identify the payee, may identify a recurring frequency, may identifying a recurring payment amount, and/or may include a first payment date for the recurring payments. In some instances a suggested first payment date may be the next due date for a payment to be made to the identified payee.

Recurring payment suggestions may or may not include a suggested payment amount. For example, if multiple transactions with a regular frequency include the same payment amount, an amount may be suggested in the recurring payment suggestion. However, according to an aspect of the invention, recurring payment suggestions may be generated even if all or a portion of the payments made to a payee do not have the same amount. The generation of these suggestions may cover a wide variety of situations in which a payment amount differs, such as, a situation in which a consumer pays varying amounts of extra principle on a mortgage payment each month or a situation in which a payment is submitted to a credit card company. For these suggestions, a payment amount may or may not be suggested. For example the suggestion may include no payment amount or the suggestion may include a minimum amount of the payments as a suggested payment amount for recurring payments.

At block 625, one or more generated recurring payment suggestions may be stored in association with the consumer in one or more suitable memory devices and/or associated data repositories, such as databases 175 or databases 180 illustrated in FIG. 1. For example, the one or more suggestions may be stored in local memory. As another example, the one or more suggestions may be stored in a memory associated with another network device by one or more web service calls. For example, a recurring payment suggestion may be generated by the EBPP service provider computer 115 and stored in a memory associated with the financial institution computer 110. When the consumer logs into a web portal provided by the financial institution computer 110, such as an electronic banking web portal, the suggestion may be presented to the consumer. As another example, a suggestion may be generated by the financial institution computer 110 and stored in a memory associated with the EBPP service provider computer 115. When the consumer logs into a web portal provided by the EBPP service provider computer 115 and, such as a bill presentation and/or payment web portal, the suggestion may be presented to the consumer.

If a recurring payment suggestion is accepted by the consumer following presentation of the suggestion to the consumer, then a recurring payment service may be initiated at a service provider for the consumer. The recurring payment service may submit payments to a payee on behalf of the consumer with a regular frequency.

The method 600 may end following block 625.

The operations described and shown in the method 600 of FIG. 6 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 6 may be performed.

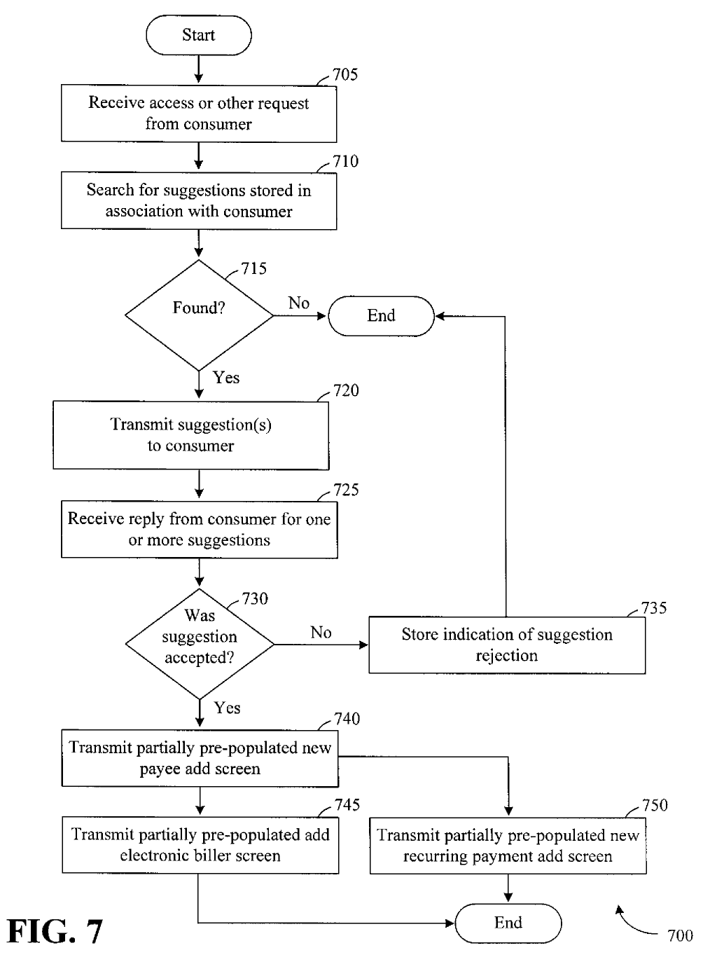

FIG. 7 is a flow chart of an example method 700 for presenting payee suggestions to a consumer, according to an example embodiment of the invention. The method 700 may be performed by a suitable service provider, such as the financial institution computer 110 or the EBPP service provider computer 115. The method 700 may begin at block 705.

At block 705, which may be optional in certain embodiments of the invention, an access request or other type of request may be received from a consumer, such as the consumer computer 105 illustrated in FIG. 1. For example, the consumer may communicate login credentials to a web server or host that is associated with the financial institution computer 110 or the EBPP service provider computer 115. The web server or host may verify the consumer based upon the login or access credentials and engage in a communications session with the consumer, such as an online banking session, an electronic bill payment and/or presentment (EBPP) session, and/or an integrated online banking and EBPP session. Additionally, the login may be treated as a request to present one or more generated suggestions to the consumer. As another example, the consumer may transmit or communicate a specific request for one or more suggestions to a web server. For example, the consumer may select a link provided by the web server that facilitates the communication of a request for suggestions to the web server.

At block 710, a search may be conducted for one or more suggestions that have been generated for and stored in association with an identity of the consumer. For example, identification information for the consumer, such as a name of the consumer, a user identifier of the consumer, and the like, may be utilized to search one or more data repositories containing suggestions for one or more consumers. The data repositories may be implemented on either local memory devices and/or remote memory devices. In certain embodiments, one or more memory devices may be accessed via one or more suitable networks, such as the networks 120 illustrated in FIG. 1. For example, one or more web service calls may be utilized to request and/or obtain one or more suggestions for the consumer.

At block 715, a determination may be made as to whether one or more suggestions for the consumer are available. If it is determined at block 715 that no suggestions are available for the consumer, then the method 700 may end. If, however, it is determined at block 715 that one or more suggestions are available for the consumer, then operations may continue at block 720.

At block 720, one or more available suggestions may be obtained and transmitted or otherwise communicated to the consumer. As desired, the available suggestions may be presented to the consumer. For example, the available suggestions may be presented to the consumer via one or more suitable web pages that are presented by the web portal or other established communications session. In certain embodiments of the invention, suggestions may be presented to the consumer in a serial manner, and a consumer response may be received for each suggestion prior to transmitting another suggestion. In other embodiments, multiple suggestions may be presented to the consumer simultaneously. For example, a list of identified payees and suggestions associated with each payee may be presented to the consumer. Additionally, as desired, some suggestions may be transmitted for presentation based upon a consumer response to an earlier presented suggestion. For example, an electronic bill presentment suggestion or a recurring payment suggestion may be transmitted after the consumer has accepted a suggestion to add an identified payee as a payee. For purposes of describing FIG. 7, it will be assumed that a new payee suggestion is transmitted to a consumer and, based upon an acceptance of the new payee suggestions, one or more other suggestions may be transmitted to the consumer.

Once a suggestion has been transmitted to and presented to the consumer, a consumer reply to the suggestion may be entered or selected, and the reply may be communicated back to a service provider. For example, the consumer may select an accept indication or a decline indication associated with a presented suggestion. For purposes of describing FIG. 7, a consumer may select an accept indication or a decline indication for a suggestion to add an identified payee as a new payee. A consumer reply to the suggestion may be transmitted to and received by the service provider at block 725.

At block 730, a determination may be made as to whether a new payee suggestion has been accepted by the consumer. A new payee suggestion may be a suggestion to add an identified payee as a new payee at a service provider for one or more services provided by the service provider. If it is determined at block 730 that a new payee suggestion has been declined or rejected by the consumer, then operations may continue at block 735. At block 735, which may be optional in certain embodiments of the invention, an indication of the rejection may be stored in one or more suitable memory devices or data repositories. In this regard, subsequent suggestions for the payee may not be generated based on the rejection and/or consumer preferences.

If, however, it is determined at block 730 that a new payee suggestion has been accepted by the consumer, then operations may continue at block 740. At block 740, a partially pre-populated new payee add screen or graphical user interface may be transmitted or otherwise communicated to the payee. The new payee add screen may be partially pre-populated with a wide variety of information associated with the payee and/or the consumer including, but not limited to, a payee name, a payee address, an account number of the consumer with the payee, a payee consumer service telephone number, etc. The consumer may review the information included in the payee add screen, and the consumer may revise, edit, and or supplement the information as desired. Once the consumer has approved of the information in the payee add screen, the payee may be added as a new payee for the consumer at the service provider.

At block 745, which may be optional in various embodiments of the invention, a partially pre-populated electronic biller activation screen or display may be transmitted or otherwise communicated to the consumer. For example, an electronic biller activation screen may be transmitted to the consumer if the identified payee has been determined to be an electronic biller for whom bills may be presented electronically. The electronic biller activation screen may facilitate the activation of electronic bill presentment at the service provider of bills of the payee for the consumer. Similar to the new payee add screen, a consumer may review information included in the electronic biller activation screen, and the consumer may modify or supplement the information as desired. The consumer may accept or decline the suggestion to activate electronic bill presentment for the payee.

At block 750, which may be optional in certain embodiments of the invention, a partially pre-populated recurring payment activation screen or display may be transmitted or otherwise communicated to the consumer. For example, a recurring payment activation screen may be transmitted to the consumer if a pattern of payments to the identified payee has been identified. The recurring payment activation screen may facilitate the establishment and/or activation of recurring payments to the payee on behalf of the consumer. Similar to the new payee add screen, a consumer may review information included in the recurring payment activation screen, and the consumer may modify or supplement the information as desired. The consumer may accept or decline the suggestion to activate recurring payments to the payee.

As an alternative to presenting suggestions to a consumer via a web portal or other network session, suggestions may be transmitted or communicated to the consumer utilizing a wide variety of proactive communication techniques, for example, email, SMS messaging, etc. These suggestions may include one or more links, such as hypertext links, to a service provider. Selection of a hypertext link by the consumer may establish a communications session with a service provider and allow the consumer to accept or decline a suggestion. The communications session may further facilitate setting up the payee as a payee of the consumer for one or more services offered by the service provider.

The operations described and shown in the method 700 of FIG. 7 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 7 may be performed.

Accordingly, example embodiments of the invention can provide the technical effects of creating a system, method, and apparatus that identifies payees from cleared items posted to a financial account and automatically generates suggestions to enroll a consumer for additional services associated with the payee, such as electronic billing services and/or payment distribution services. In this regard, greater convenience may be provided to a consumer and the consumer may avoid the time consuming task of identifying payees for which additional services may be provided.

Various block and/or flow diagrams of systems, methods, apparatuses, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1 A method, comprising:
obtaining information associated with one or more cleared items posted to a financial account of a consumer;
identifying, based at least in part on the obtained information, at least one payee of the consumer;
generating a suggestion to add the identified at least one payee as one of an electronic biller of the consumer or a payee of the consumer for online payment functionality, wherein receiving an acceptance of the suggestion facilitates activation of an associated service for the consumer by a service provider; and
transmitting the generated suggestion to a network entity for presentation to the consumer,
wherein at least one of the identifying or generating is performed by one or more computers.

2. The method of claim 1, further comprising:
identifying a pattern of payments made to the at least one payee; and
generating a suggestion to activate recurring payments to the at least one payee.

3. The method of claim 2, wherein identifying a pattern of payments made to the at least one payee comprises identifying payments having at least one of a regular frequency or a same transaction amount.

4. The method of claim 1, wherein the one or more cleared items include at least one of a check transaction, a converted check transaction, a debit card transaction, or a direct debit transaction.

5. The method of claim 1, wherein the one or more cleared items include a check transaction, and
wherein identifying at least one payee comprises identifying a payee from a check image associated with the check transaction.

6. The method of claim 1, further comprising:
filtering the obtained one or more cleared items to remove one or more irrelevant transactions prior to identifying the at least one payee.

7. The method of claim 6, wherein the one or more irrelevant transactions comprise at least one of credit transactions, online payments, withdrawals, or bank fees.

8. The method of claim 1, further comprising:
searching a data repository comprising information associated with managed payees of the service provider for the at least one identified payee;
determining, based at least in part on the search, whether the at least one identified payee is a managed payee of the service provider; and
accessing information associated with the managed payee generating the suggestion.

9. The method of claim 8, wherein searching a data repository comprises searching the data repository utilizing one or more of a name of the identified payee, a normalized name of the identified payee, or a name variant for the identified payee.

10. The method of claim 1, wherein the one or more cleared items include a check transaction, and further comprising:
identifying a potential account number from a check image associated with the check transaction.

11. The method of claim 10, further comprising:
scheming the potential account number utilizing one or more merchant account scheming rules associated with the identified payee.

12. The method of claim 1, further comprising:
obtaining at least one consumer preference associated with analyzing one or more cleared items; and
filtering the one or more cleared items based at least in part on the obtained at least one consumer preference.

13. The method of claim 1, further comprising:
obtaining at least one consumer preference associated with generating suggestions; and
determining whether to generate the suggestion based at least in part on the obtained at least one consumer preference.

14. The method of claim 1, further comprising:
storing the generated suggestion in a memory,
wherein transmitting the generated suggestion to a network entity for presentation to the consumer comprises:
receiving a request from the consumer to initiate an online banking communications session;
accessing the stored suggestion; and
transmitting the generated suggestion for presentation to the consumer.

15. The method of claim 1, further comprising:
receiving an acceptance of the generated suggestion from the consumer; and
transmitting, to the network entity for presentation to the consumer and in response to the acceptance, a partially pre-populated form for initiating the associated service.

16. The method of claim 1, wherein identifying at least one payee comprises identifying at least one payee by one of a financial institution that manages the financial account or an electronic bill presentment and payment service provider.

17. A system, comprising:
a communications interface operable to transmit one or more generated suggestions to a network entity for presentation to a consumer; and
at least one processor operable (i) to obtain information associated with one or more cleared items posted to a financial account of the consumer, (ii) to identify at least one payee based at least in part on the obtained information, (ii) to generate a suggestion to add the identified at least one payee as one of an electronic biller of the consumer or a payee of the consumer for online payment functionality, wherein receiving an acceptance of the suggestion facilitates activation of an associated service for the consumer by a service provider, and (iv) to direct the communications interface to transmit the generated suggestion.

18. The system of claim 17, wherein the at least one processor is further operable to:
identify a pattern of payments made to the at least one payee; and
generate a suggestion to activate recurring payments to the at least one payee.

19. The system of claim 18, wherein the at least one processor is operable to identify the pattern by identifying payments having at least one of a regular frequency or a same transaction amount.

20. The system of claim 17, wherein the one or more cleared items include at least one of a check transaction, a converted check transaction, a debit card transaction, or a direct debit transaction.

21. The system of claim 17, wherein the one or more cleared items include a check transaction, and
wherein the at least one processor is operable to identify the at least one payee by identifying a payee from a check image associated with the check transaction.

22. The system of claim 17, where the at least one processor is further operable to filter the obtained one or more cleared items to remove one or more irrelevant transactions prior to identifying the at least one payee.

23. The system of claim 22, wherein the one or more irrelevant transactions comprise at least one of credit transactions, online payments, withdrawals, or bank fees.

24. The system of claim 17, further comprising:
a data repository comprising information associated with managed payees of the service provider,
wherein the data repository is searched for the at least one identified payee and at least a portion of the stored information associated with a managed payee is utilized in the generation of the suggestion if the at least one identified payee is determined to match the managed payee.

25. The system of claim 24, wherein the data repository is searched utilizing one or more of a name of the identified payee, a normalized name of the identified payee, or a name variant for the identified payee.

26. The system of claim 17, wherein the one or more cleared items include a check transaction, and wherein the at least one processor is further operable to:
identify a potential account number from a check image associated with the check transaction.

27. The system of claim 26, wherein the at least one processor is further operable to:
scheme the potential account number utilizing one or more merchant account scheming rules associated with the identified payee.

28. The system of claim 17, wherein the at least one processor is further operable to:
obtain at least one consumer preference associated with analyzing one or more cleared items; and
filter the one or more cleared items based at least in part on the obtained at least one consumer preference.

29. The system of claim 17, wherein the at least one processor is further operable to:
obtain at least one consumer preference associated with generating suggestions; and
determine whether to generate the suggestion based at least in part on the obtained at least one consumer preference.

30. The system of claim 17, further comprising:
a memory operable to store the generated suggestion,
wherein the stored generated suggestion is accessed from the memory and transmitted to the network entity for presentation to the consumer in response to receiving a request from the consumer to initiate an online banking communications session.

31. The system of claim 17, wherein:
the communications interface is further operable to receive an acceptance of the generated suggestion and to transmit, to the network entity for presentation to the consumer, a partially pre-populated enrollment form associated with a suggested service,
wherein the at least one processor is further operable to direct the communications interface to transmit the enrollment form in response to the received acceptance.

32. A system, comprising:
means for obtaining information associated with one or more cleared items posted to a financial account of a consumer;
means for identifying, by a payee prediction processor and based at least in part on the obtained information, at least one payee;
means for generating a suggestion to add the identified at least one payee as one of an electronic biller of the consumer or a payee of the consumer for online payment functionality, wherein receiving an acceptance of the suggestion facilitates activation of an associated service for the consumer by a service provider; and
means for transmitting the generated suggestion to a network entity for presentation to the consumer.
